(19) United States
(12) Patent Application Publication
(10) Pub. No.: US 2026/0121706 A1
(43) Pub. Date: Apr. 30, 2026

(54) PHASE ALIGNMENT FOR PRECODERS

(71) Applicant: QUALCOMM Incorporated, San Diego, CA (US)

(72) Inventors: Chenxi HAO, Beijing (CN); Jay Kumar SUNDARARAJAN, San Diego, CA (US); Taesang YOO, San Diego, CA (US); Pavan Kumar VITTHALADEVUNI, San Diego, CA (US); Liangming WU, Beijing (CN); June NAMGOONG, San Diego, CA (US)

(21) Appl. No.: 19/116,703

(22) PCT Filed: Oct. 27, 2023
(86) PCT No.: PCT/CN2023/127063

§ 371 Date: Mar. 28, 2025

(30) Foreign Application Priority Data
Nov. 11, 2022 (WO) PCTCN2022131420

(51) Int. Cl. H04B 7/0456

(52) U.S. Cl. CPC H04B 7/046

(57) ABSTRACT

Various aspects of the present disclosure generally relate to wireless communication. In some aspects, a user equipment (UE) may perform a measurement on a reference signal. Accordingly, the UE may transmit a meta indicator. The meta indicator may represent one or more properties associated with processing of the reference signal at the UE. Numerous other aspects are described.

### REFERENCE TO RELATED APPLICATION

This patent application claims priority to Patent Cooperation Treaty (PCT) Application No. PCT/CN2022/131420, filed on Nov. 11, 2022, entitled “PHASE ALIGNMENT FOR PRECODERS,” and is assigned to the assignee hereof. The disclosure of the prior application is considered part of and is incorporated by reference into this patent application.

### INTRODUCTION

Aspects of the present disclosure generally relate to wireless communication and to techniques and apparatuses for determining precoders.

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to an apparatus for wireless communication at a user equipment (UE). The apparatus may include one or more memories and one or more processors coupled to the one or more memories. The one or more processors may be configured to cause the UE to perform a measurement on a reference signal. The one or more processors may be configured to cause the UE to determine a precoding matrix based on the measurement. The one or more processors may be configured to cause the UE to apply a phase rotation to the precoding matrix to generate a rotated precoding matrix. The one or more processors may be configured to cause the UE to transmit a report based at least in part on the rotated precoding matrix.

Some aspects described herein relate to an apparatus for wireless communication at a UE. The apparatus may include one or more memories and one or more processors coupled to the one or more memories. The one or more processors may be configured to cause the UE to perform a measurement on a reference signal. The one or more processors may be configured to cause the UE to transmit a meta indicator representing one or more properties associated with processing of the reference signal at the UE.

Some aspects described herein relate to an apparatus for wireless communication at a network node. The apparatus may include one or more memories and one or more processors coupled to the one or more memories. The one or more processors may be configured to cause the network node to transmit a reference signal. The one or more processors may be configured to cause the network node to receive a report based at least in part on a rotated precoding matrix based on a first singular value decomposition (SVD) algorithm and a measurement of the reference signal. The one or more processors may be configured to cause the network node to receive output from a decoder trained on output from a second SVD algorithm and accepting input from the report.

Some aspects described herein relate to an apparatus for wireless communication at a network node. The apparatus may include one or more memories and one or more processors coupled to the one or more memories. The one or more processors may be configured to cause the network node to transmit a reference signal. The one or more processors may be configured to cause the network node to receive a meta indicator representing one or more properties associated with processing of the reference signal at a UE.

Some aspects described herein relate to a method of wireless communication performed at a UE. The method may include performing a measurement on a reference signal. The method may include determining a precoding matrix based on the measurement. The method may include applying a phase rotation to the precoding matrix to generate a rotated precoding matrix. The method may include transmitting a report based at least in part on the rotated precoding matrix.

Some aspects described herein relate to a method of wireless communication performed at a UE. The method may include performing a measurement on a reference signal. The method may include transmitting a meta indicator representing one or more properties associated with processing of the reference signal at the UE.

Some aspects described herein relate to a method of wireless communication performed at a network node. The method may include transmitting a reference signal. The method may include receiving a report based at least in part on a rotated precoding matrix based on a first SVD algorithm and a measurement of the reference signal. The method may include receiving output from a decoder trained on output from a second SVD algorithm and accepting input from the report.

Some aspects described herein relate to a method of wireless communication performed at a network node. The method may include transmitting a reference signal. The method may include receiving a meta indicator representing one or more properties associated with processing of the reference signal at a UE.

Some aspects described herein relate to a non-transitory computer-readable medium that stores a set of instructions for wireless communication by a UE. The set of instructions, when executed by one or more processors of the UE, may cause the UE to perform a measurement on a reference signal. The set of instructions, when executed by one or more processors of the UE, may cause the UE to determine a precoding matrix based on the measurement. The set of instructions, when executed by one or more processors of the UE, may cause the UE to apply a phase rotation to the precoding matrix to generate a rotated precoding matrix. The set of instructions, when executed by one or more processors of the UE, may cause the UE to transmit a report based at least in part on the rotated precoding matrix.

Some aspects described herein relate to a non-transitory computer-readable medium that stores a set of instructions for wireless communication by a UE. The set of instructions, when executed by one or more processors of the UE, may cause the UE to perform a measurement on a reference signal. The set of instructions, when executed by one or more processors of the UE, may cause the UE to transmit a meta indicator representing one or more properties associated with processing of the reference signal at the UE.

Some aspects described herein relate to a non-transitory computer-readable medium that stores a set of instructions for wireless communication by a network node. The set of instructions, when executed by one or more processors of the network node, may cause the network node to transmit a reference signal. The set of instructions, when executed by one or more processors of the network node, may cause the network node to receive a report based at least in part on a rotated precoding matrix based on a first SVD algorithm and a measurement of the reference signal. The set of instructions, when executed by one or more processors of the network node, may cause the network node to receive output from a decoder trained on output from a second SVD algorithm and accepting input from the report.

Some aspects described herein relate to a non-transitory computer-readable medium that stores a set of instructions for wireless communication by a network node. The set of instructions, when executed by one or more processors of the network node, may cause the network node to transmit a reference signal. The set of instructions, when executed by one or more processors of the network node, may cause the network node to receive a meta indicator representing one or more properties associated with processing of the reference signal at a UE.

Some aspects described herein relate to an apparatus for wireless communication. The apparatus may include means for performing a measurement on a reference signal. The apparatus may include means for determining a precoding matrix based on the measurement. The apparatus may include means for applying a phase rotation to the precoding matrix to generate a rotated precoding matrix. The apparatus may include means for transmitting a report based at least in part on the rotated precoding matrix.

Some aspects described herein relate to an apparatus for wireless communication. The apparatus may include means for performing a measurement on a reference signal. The apparatus may include means for transmitting a meta indicator representing one or more properties associated with processing of the reference signal at the apparatus.

Some aspects described herein relate to an apparatus for wireless communication. The apparatus may include means for transmitting a reference signal. The apparatus may include means for receiving a report based at least in part on a rotated precoding matrix based on a first SVD algorithm and a measurement of the reference signal. The apparatus may include means for receiving output from a decoder trained on output from a second SVD algorithm and accepting input from the report.

Some aspects described herein relate to an apparatus for wireless communication. The apparatus may include means for transmitting a reference signal. The apparatus may include means for receiving a meta indicator representing one or more properties associated with processing of the reference signal at a UE.

Aspects generally include a method, apparatus, system, computer program product, non-transitory computer-readable medium, user equipment, base station, network entity, network node, wireless communication device, and/or processing system as substantially described with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment in a wireless network, in accordance with the present disclosure.

FIG. 3 is a diagram illustrating an example disaggregated base station architecture, in accordance with the present disclosure.

FIG. 4 is a diagram illustrating an example of reporting a precoding matrix indicator, in accordance with the present disclosure.

FIG. 5A is a diagram illustrating an example of artificial intelligence/machine learning based beam management, in accordance with the present disclosure.

FIG. 5B is a diagram illustrating an example of channel feedback using an encoder and a decoder, in accordance with the present disclosure.

FIG. 6A is a diagram illustrating an example of a data collection phase and a training phase for an encoder and a decoder, in accordance with the present disclosure.

FIG. 6B is a diagram illustrating an example of an inference for an encoder and a decoder, in accordance with the present disclosure.

FIGS. 7 and 8A are diagrams illustrating examples associated with applying phase alignment for precoders, in accordance with the present disclosure.

FIG. 8B is a diagram illustrating an example associated with reporting using a meta indicator.

FIG. 9 is a diagram illustrating an example process associated with applying phase alignment for precoders, in accordance with the present disclosure.

FIG. 10 is a diagram illustrating an example process associated with decoding phase aligned precoders, in accordance with the present disclosure.

FIGS. 11 and 12 are diagrams illustrating example processes associated with reporting using a meta indicator, in accordance with the present disclosure.

FIG. 13 is a diagram of an example apparatus for wireless communication, in accordance with the present disclosure.

FIG. 14 is a diagram illustrating an example of a hardware implementation for an apparatus employing a processing system, in accordance with the present disclosure.

FIG. 15 is a diagram illustrating an example of an implementation of code and circuitry for an apparatus, in accordance with the present disclosure.

FIG. 16 is a diagram of an example apparatus for wireless communication, in accordance with the present disclosure.

FIG. 17 is a diagram illustrating an example of a hardware implementation for an apparatus employing a processing system, in accordance with the present disclosure.

FIG. 18 is a diagram illustrating an example of an implementation of code and circuitry for an apparatus, in accordance with the present disclosure.

### DETAILED DESCRIPTION

In order to improve quality and reliability of transmissions from a network to a user equipment (UE), the network may request that the UE measure a reference signal (e.g., a channel state information (CSI) reference signal (CSI-RS) or another type of reference signal) and provide a report (e.g., a CSI report) based on a measurement of the reference signal. For example, the UE may determine a channel matrix (e.g., represented by H) representing the measurement. Based on the channel matrix, the UE may use a codebook (e.g., previously indicated by the network and/or programmed into a memory of the UE) to identify one or more best codewords for decoding the reference signal. The UE transmits a sequence of bits that encodes the report and thus encodes a precoding matrix indicator (PMI) that indicates the best codeword(s).

One technique to capture more channel information in the sequence of bits that encodes the report is to apply an encoder (e.g., a machine learning model) at the UE in lieu of a codebook. The encoder may correspond to a decoder (e.g., a machine learning model trained in parallel with the encoder) at the network. For example, the encoder may accept, as input, a precoder (e.g., represented by V) based on the channel matrix H and may produce, as output, a compressed representation of the precoder V that the UE may encode in the report. The corresponding decoder may accept, as input, the compressed representation of the precoder V and produce, as output, a reconstructed precoder (e.g., represented by V*). The UE may calculate the precoder V by applying singular value decomposition (SVD) to the channel matrix H. As used herein, “singular value decomposition” or “SVD” refers to factorization of a real or complex matrix (in this example, the channel matrix H) into two complex unitary matrices (one of which is the precoder V in this example) as well as a rectangular diagonal matrix. By performing SVD, the UE may estimate the precoder that that the network applied to the reference signal before transmission. Applying different SVD algorithms may result in unitary matrices with different phases.

In order to train the encoder and the decoder, the network may, during a data collection phase, transmit reference signals to multiple UEs and receive, from the UEs, both channel matrices and precoders based on the reference signals. In one training example, during a training phase, the network (or a training entity at the network) may train the encoder and the decoder in parallel using the channel matrices and the precoders. The network (or the training entity) may refine the encoder and the decoder during a refinement phase. For example, during the refinement phase, the network may again transmit reference signals to multiple UEs and receive, from the UEs, both precoders based on the reference signals and outputs from the encoder. Accordingly, the network (or the training entity) may refine the encoder and the decoder in parallel using the outputs and the precoders. The refined encoder and decoder may therefore be used to improve communications between a UE and the network. For example, during an inference phase, a UE may apply a refined encoder and encode output from the refined encoder into a report to the network. As a result, the UE reports compressed information (that is, output from the encoder), and the network may recover more information (e.g., by applying the decoder) about a channel between the UE and the network in order to better schedule downlink transmissions to the UE based on the information about the channel. This example is often referred to as “centralized” training because the training entity at the network performs all training and refinement.

In another training example, the encoder at the UE and the decoder at the network are trained at the UE side and at the network side, respectively, in the same training session. That is, in each training session, a training entity at the UE provides output from the encoder as activation to the decoder at the network. A training entity at the network uses the activation as the input to the decoder and calculates the loss value associated with a current iteration. The loss value may be used to generate a gradient (e.g., for back-propagation), and the network may provide the gradient to the UE side training entity for the training entity at the UE to update the encoder. The same procedure may be repeated until a loss threshold or condition is satisfied. In this example, the UE may provide data the training entity at the UE, and the training entity at the network also obtains ground-truth for loss calculation from the UE (or the training entity at the UE). Therefore, the training entity at the UE may update the encoder with newly collected data by requesting the activation (for back-propagation) from the training entity at the network. Alternatively, the training entity at the network may update the decoder with newly collected data by requesting the activation (for back-propagation) from the training entity at the UE.

In another training example, the encoder at the UE and the decoder at the network are trained sequentially. For network-first training, the training entity at the network trains an encoder-decoder pair. The network provides input and encoder output to the training entity at the UE. The training entity at the UE may use the input and the encoder output to train its own encoder to ensure interoperability with the decoder of the network. Finally, the decoder trained by the training entity at the network and the encoder trained by the training entity at the UE may be used together. Accordingly, the UE (or the training entity at the UE) may provide data to the training entity at the network, and the network (or the training entity at the network) may provide trained encoder output to the training entity at the UE. For UE-first training, the training entity at the UE trains the encoder-decoder pair and provides encoder output and decoder output to the training entity at the network. The training entity at the network may use the encoder output and decoder output to train its own encoder to ensure interoperability with the encoder of the UE. Finally, the decoder trained by the training entity at the network and the encoder trained by the training entity at the UE may be used together.

Some techniques and apparatuses described herein provide for phase rotation applied to a precoder at a UE before the UE uses the precoder as input to an encoder (e.g., during an inference phase) or before the UE reports the precoder to a network (e.g., during a data collection phase). Applying phase rotation reduces differences across precoders that are calculated using different SVD algorithms by aligning phases of entries in the precoder. Therefore, applying phase rotation improves accuracy of training (and refinement) of the encoder and the decoder during a training phase (or a refinement phase). Because the decoder is more accurate, accuracy of output from the decoder (which may be a reconstructed precoder determined by the network based on a compressed precoder reported by the UE) during the inference phase. Improved accuracy results in improved quality and reliability of communications between UEs and the network because the network configures channels between the UEs and the network based on more accurate reports.

Alternatively, the UE may apply phase rotation to the precoder before using the precoder to report a PMI to the network. Applying phase rotation reduces overhead when the UE performs frequency compression on the precoder to select codewords (and thus select the PMI). Therefore, applying phase rotation conserves power, processing resources, and memory usage at the UE.

In some aspects, the UE may report measurements with a meta indicator during the data collection phase. As used herein, “meta indictor” refers to an indicator that is associated with information about a UE without expressly indicating the information. For example, the meta indicator may be associated with a cluster, out of a plurality of clusters, that includes the UE. A cluster may represent a group of UEs that share properties (e.g., exhibiting properties within a range, and/or satisfying a threshold, associated with the cluster). Accordingly, the network may infer properties associated with the UE from the meta indicator (e.g., a precoder applied by the UE, an antenna configuration associated with the UE, a beamforming configuration used by the UE, a phase rotation algorithm applied by the UE, and/or an SVD algorithm applied by the UE, among other examples) without the UE expressly reporting the properties. As a result, the network may use the meta indicator to improve accuracy of training (and refinement) of the encoder and the decoder during a training phase (or a refinement phase). Additionally, privacy is preserved because the UE refrains from reporting detailed properties about itself to the network.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

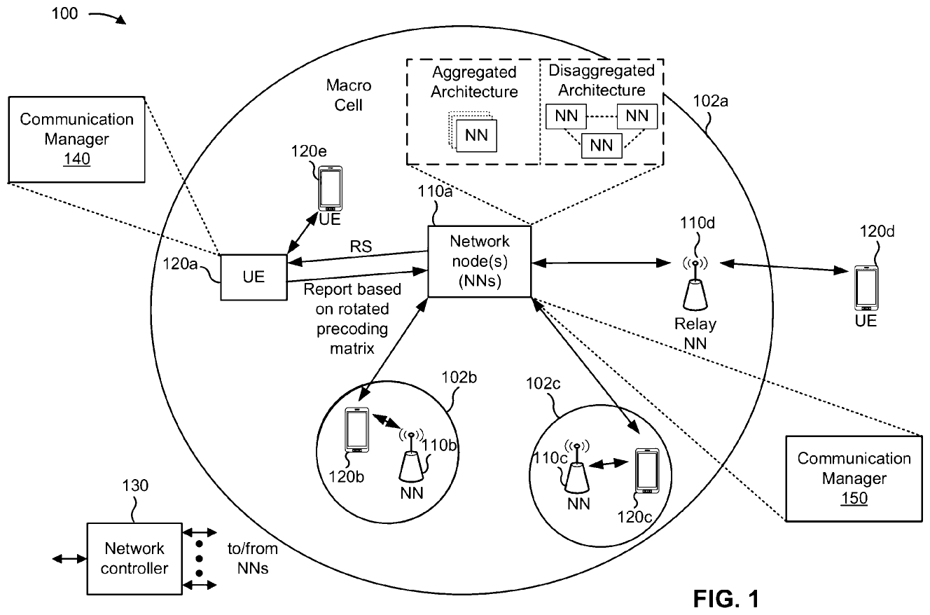

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

The electromagnetic spectrum is often subdivided, by frequency/wavelength, into various classes, bands, channels, etc. In 5G NR, two initial operating bands have been identified as frequency range designations FR1 (410 MHz-7.125 GHz) and FR2 (24.25 GHZ-52.6 GHZ). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As shown in FIG. 1 and described in more detail elsewhere herein, the communication manager 140 may perform a measurement on a reference signal (RS), may determine a precoding matrix based on the measurement and apply a phase rotation to the precoding matrix to generate a rotated precoding matrix, and may transmit a report (e.g., to the network node 110) based at least in part on the rotated precoding matrix. Additionally, or alternatively, and as described in more detail elsewhere herein, the communication manager 140 may perform a measurement on an RS and may transmit a meta indicator, where the meta indicator represents one or more properties associated with processing of the RS at the UE 120. Additionally, or alternatively, the communication manager 140 may perform one or more other operations described herein.

In some aspects, the network node 110 may include a communication manager 150. As shown in FIG. 1 and described in more detail elsewhere herein, the communication manager 150 may transmit an RS, may receive a report based at least in part on a rotated precoding matrix based on a first SVD algorithm and a measurement of the reference signal, and may receive output from a decoder trained on output from a second SVD algorithm and accepting input from the report. Additionally, or alternatively, and as described in more detail elsewhere herein, the communication manager 150 may transmit an RS and may receive a meta indicator, where the meta indicator represents one or more properties associated with processing of the RS at a UE (e.g., the UE 120). Additionally, or alternatively, the communication manager 150 may perform one or more other operations described herein.

As indicated above, FIG. 1 is provided as an example. Other examples may differ from what is described with regard to FIG. 1.

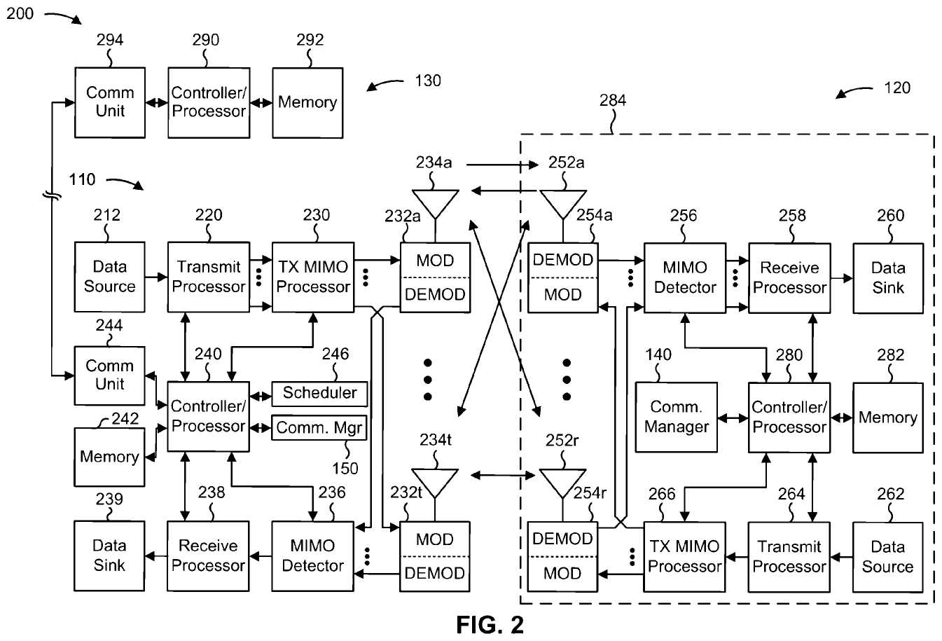

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein.

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein.

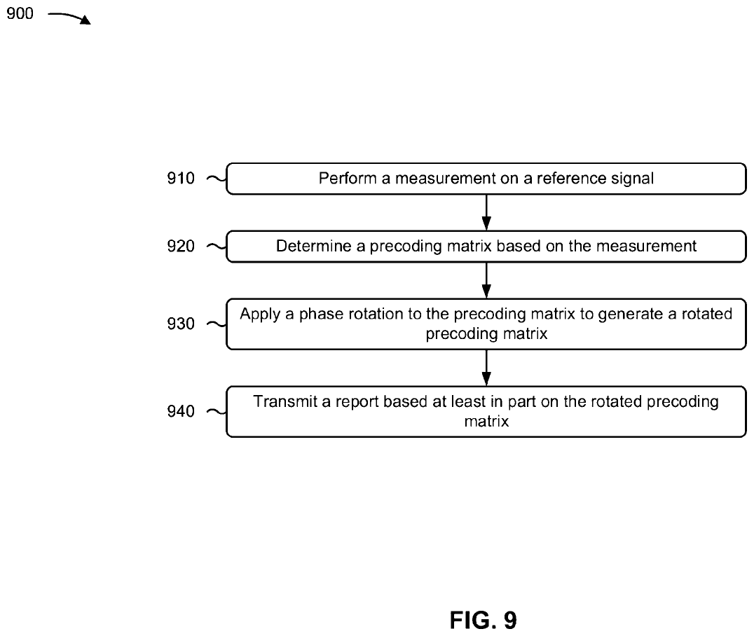

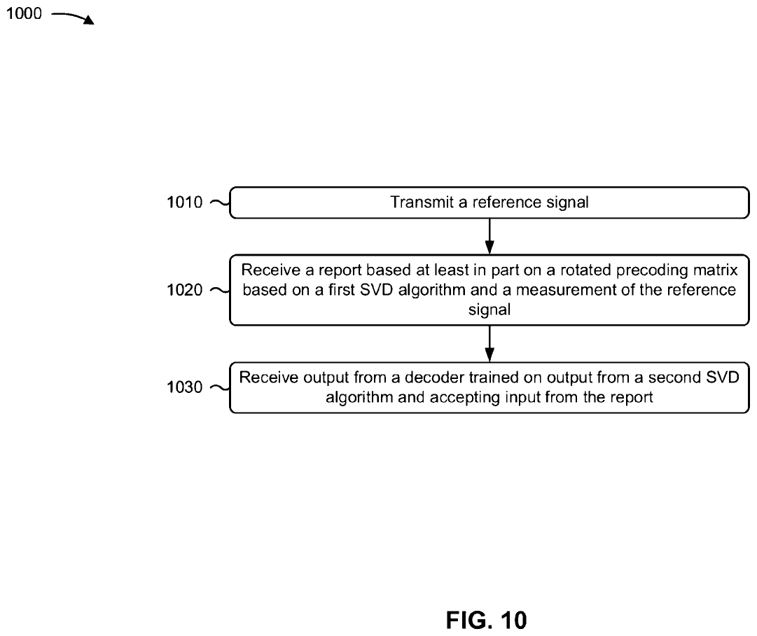

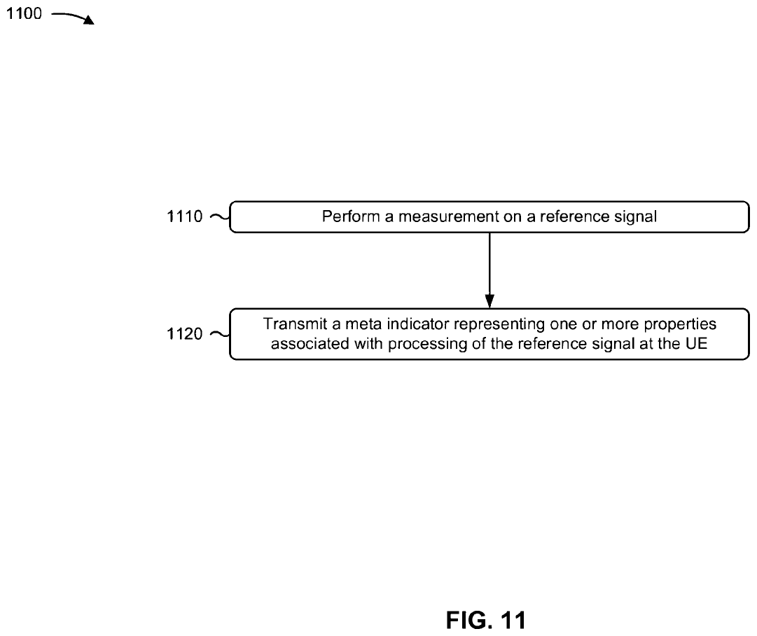

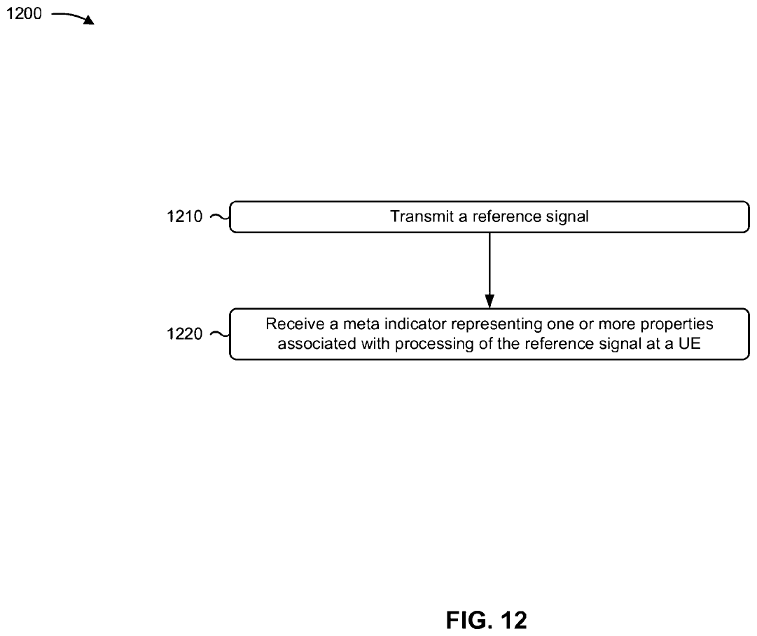

The controller/processor 240 of the network node 110, the controller/processor 280 of the UE 120, and/or any other component(s) of FIG. 2 may perform one or more techniques associated with applying phase alignment for precoders, as described in more detail elsewhere herein. For example, the controller/processor 240 of the network node 110, the controller/processor 280 of the UE 120, and/or any other component(s) of FIG. 2 may perform or direct operations of, for example, process 900 of FIG. 9, process 1000 of FIG. 10, process 1100 of FIG. 11, process 1200 of FIG. 12, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 900 of FIG. 9, process 1000 of FIG. 10, process 1100 of FIG. 11, process 1200 of FIG. 12, and/or other processes as described herein. In some examples, executing instructions may include running the instructions, converting the instructions, compiling the instructions, and/or interpreting the instructions, among other examples.

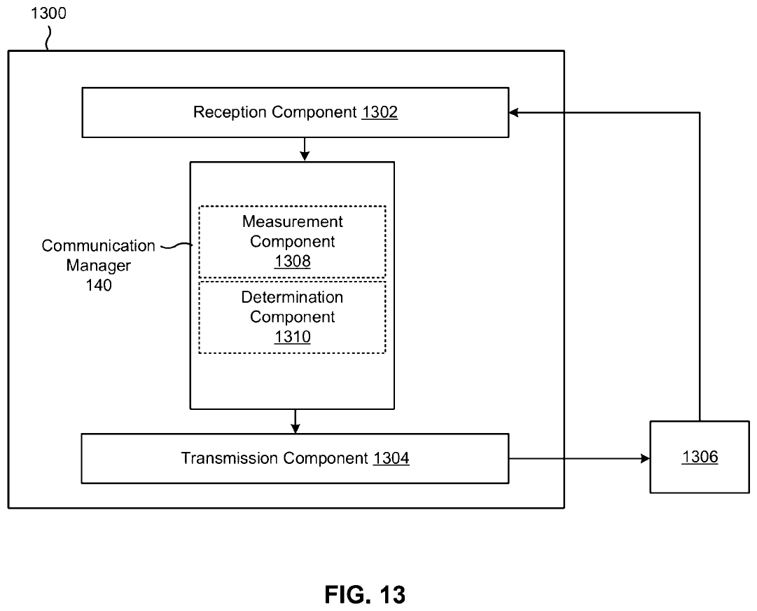

In some aspects, a UE (e.g., the UE 120 and/or apparatus 1300 of FIG. 13) may include means for performing a measurement on a reference signal; means for determining a precoding matrix based on the measurement; means for applying a phase rotation to the precoding matrix to generate a rotated precoding matrix; and/or means for transmitting a report based at least in part on the rotated precoding matrix. Additionally, or alternatively, the UE may include means for performing a measurement on a reference signal and/or means for transmitting a meta indicator representing one or more properties associated with processing of the reference signal at the UE. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

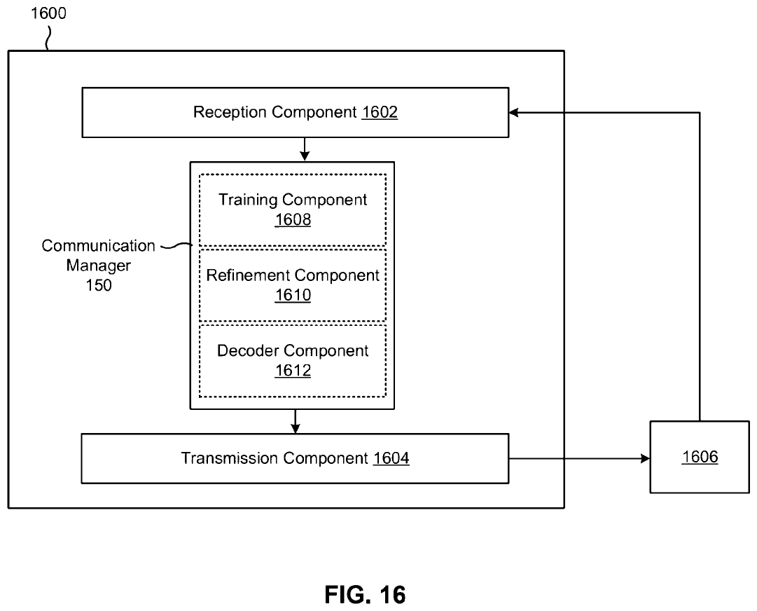

In some aspects, a network node (e.g., the network node 110, an RU 340, a DU 330, a CU 310, and/or apparatus 1600 of FIG. 16) may include means for transmitting a reference signal; means for receiving a report based at least in part on a rotated precoding matrix based on a first SVD algorithm and a measurement of the reference signal; and/or means for receiving output from a decoder trained on output from a second SVD algorithm and accepting input from the report. Additionally, or alternatively, the network node may include means for transmitting a reference signal and/or means for receiving a meta indicator representing one or more properties associated with processing of the reference signal at a UE (e.g., the UE 120 and/or apparatus 1300 of FIG. 13). The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

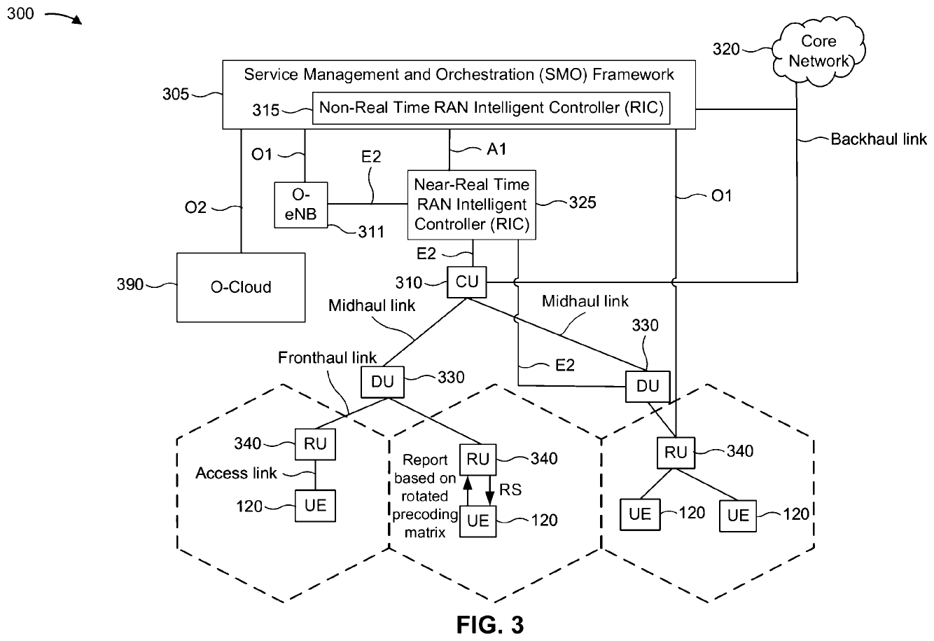

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

As shown in FIG. 3, an RU 340 may transmit an RS, and a UE 120 may perform a measurement on the RS. Accordingly, as described herein, the UE 120 may determine a precoding matrix based on the measurement and apply a phase rotation to the precoding matrix to generate a rotated precoding matrix. The precoding matrix, and thus the rotated precoding matrix, may be based on a first SVD algorithm. As shown in FIG. 3, the UE 120 may transmit, and the RU 340 may receive, a report based at least in part on the rotated precoding matrix. The RU 340 (or a device controlling the RU 340, such as a DU 330 and/or a CU 310) may receive output from a decoder that accepts input from the report. The decoder may be trained on output from a second SVD algorithm.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

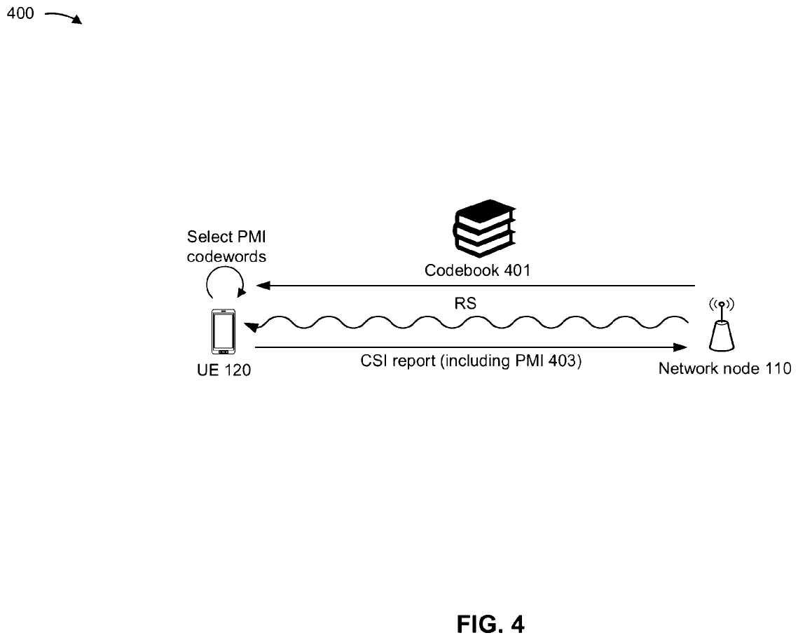

FIG. 4 is a diagram illustrating an example 400 of reporting a PMI, in accordance with the present disclosure. As shown in FIG. 4, example 400 includes a UE 120 communicating with a network node 110. The network node 110 may indicate (e.g., in a CSI report configuration) a codebook 401 for the UE 120 to use. As further shown in FIG. 4, the network node 110 may transmit an RS (e.g., a CSI-RS or another type of RS), and the UE 120 may measure the RS. Accordingly, the UE 120 uses the codebook as a PMI dictionary from which the UE 120 may select best PMI codewords. The codebook 401 functions as a PMI dictionary because the codebook may be used to lookup PMI codewords based on measurements (e.g., channel matrices or precoders). As shown in FIG. 4, the UE 120 may use a sequence of bits to report a PMI 403 (based on the best PMI codewords). Accordingly, the sequence of bits may encode a CSI report that indicates the PMI 403. The network node 110 may use the codebook 401 to determine the best PMI codewords based on the reported PMI 403. The network node 110 may therefore configure a channel between the UE 120 and the network node 110 based on the best PMI codewords.

As indicated above, FIG. 4 is provided as an example. Other examples may differ from what is described with respect to FIG. 4.

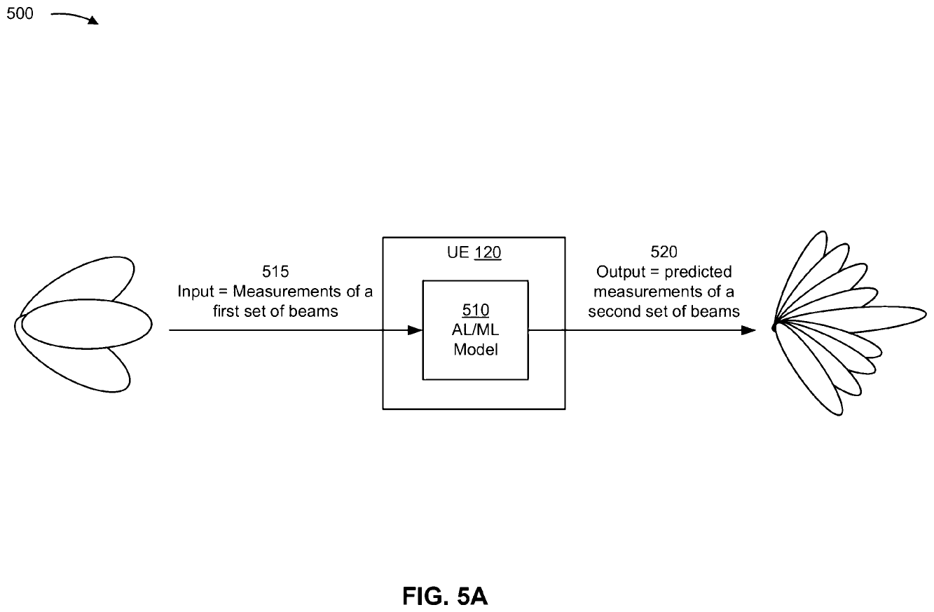

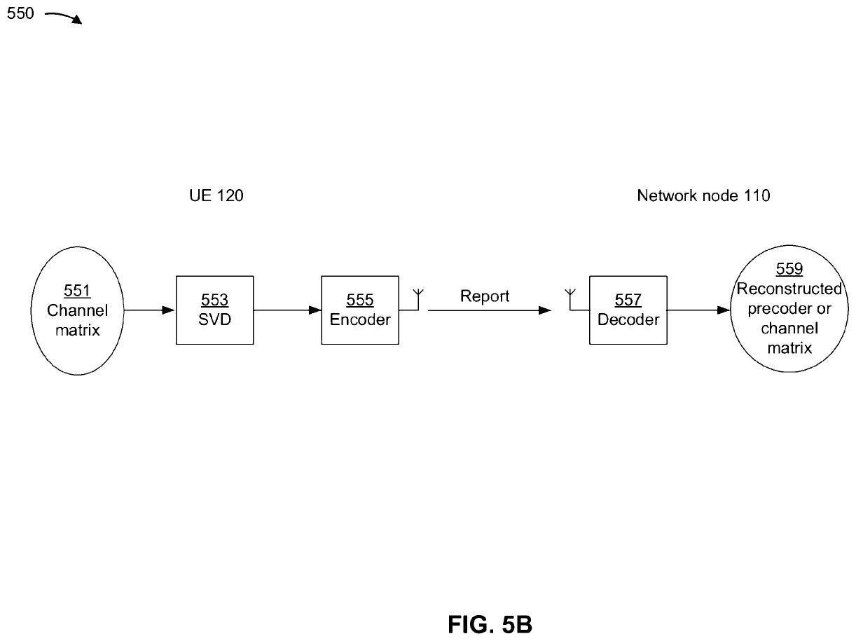

FIG. 5A is a diagram illustrating an example 500 of an AI/ML based beam management, in accordance with the present disclosure. As shown in FIG. 5A, an AI/ML model 510 may be deployed at or on a UE 120. For example, a model inference host (such as a model inference host) may be deployed at, or on, a UE 120. The AI/ML model 510 may enable the UE 120 to determine one or more inferences or predictions based on data input to the AI/ML model 510.

For example, as shown by reference number 515, an input to the AI/ML model 510 may include measurements associated with a first set of beams. For example, a network node 110 may transmit one or more signals using respective beams from the first set of beams. The UE 120 may perform measurements (e.g., L1 RSRP measurements or other measurements) of the first set of beams to obtain a first set of measurements. For example, each beam, from the first set of beams, may be associated with one or more measurements performed by the UE 120. The UE 120 may input the first set of measurements (e.g., L1 RSRP measurement values) into the AI/ML model 510 along with information associated with the first set of beams and/or a second set of beams, such as a beam direction (e.g., spatial direction), beam width, beam shape, and/or other characteristics of the respective beams from the first set of beams and/or the second set of beams.

As shown by reference number 520, the AI/ML model 510 may output one or more predictions. The one or more predictions may include predicted measurement values (e.g., predicted L1 RSRP measurement values) associated with the second set of beams. This may reduce a quantity of beam measurements that are performed by the UE 120, thereby conversing power of the UE 120 and/or network resources that would have otherwise been used to measure all beams included in the first set of beams and the second set of beams. This type of prediction may be referred to as a codebook based spatial domain selection or prediction.

As another example, an output of the AI/ML model 510 may include a point-direction, an angle of departure (AoD), and/or an angle of arrival (AoA) of a beam included in the second set of beams. This type of prediction may be referred to as a non-codebook based spatial domain selection or prediction. As another example, multiple measurement report or values, collected at different points in time, may be input to the AI/ML model 510. This may enable the AI/ML model 510 to output codebook based and/or non-codebook based predictions for a measurement value, an AoD, and/or an AoA, among other examples, of a beam at a future time. The output(s) of the AI/ML model 510, as described herein, may facilitate initial access procedures, secondary cell group (SCG) setup procedures, beam refinement procedures (e.g., a P2 beam management procedure or a P3 beam management procedure), link quality or interference adaptation procedure, beam failure and/or beam blockage predictions, and/or radio link failure predictions, among other examples.

In some examples, the first set of beams may be referred to as Set B beams and the second set of beams may be referred to as Set A beams. In some examples, the first set of beams (e.g., the Set B beams) may be a subset of the second set of beams (e.g., the Set A beams). In some other examples, the first set of beams and the second set of beams may be different beams and/or may be mutually exclusive sets. For example, the first set of beams (e.g., the Set B beams) may include wide beams (e.g., unrefined beams or beams having a beam width that satisfies a first threshold) and the second set of beams (e.g., the Set A beams) may include narrow beams (e.g., refined beams or beams having a beam width that satisfies a second threshold). In one example, the AI ML model 510 may perform spatial-domain downlink beam predictions for beams included in the Set A beams based on measurement results of beams included in the Set B beams. As another example, the AI/ML model 510 may perform temporal downlink beam prediction for beams included in the Set A beams based on historic measurement results of beams included in the Set B beams.

FIG. 5B is a diagram illustrating an example 550 of channel feedback using an encoder and a decoder, in accordance with the present disclosure. As shown in FIG. 5B, example 550 includes a UE 120 communicating with a network node 110. In order to improve reporting accuracy, the UE 120 and the network node 110 use artificial intelligence-based (AI-based) CSI feedback that includes an encoder (e.g., encoder 555) and a decoder (e.g., decoder 557) in lieu of a codebook (e.g., described in connection with FIG. 4).

Accordingly, the network node 110 may transmit an RS (e.g., a CSI-RS or another type of RS), and the UE 120 may measure the RS to determine a downlink channel matrix 551 (e.g., represented by H). The UE 120 may further apply SVD (e.g., using an SVD algorithm 553) to derive a downlink precoder (e.g., represented by V) from the downlink channel matrix 551. The UE 120 may apply the encoder 555 to generate a compressed representation of the downlink precoder V, and the UE 120 may use a sequence of bits to report the compressed representation to the network node 110. Accordingly, the encoder is analogous to a PMI searching algorithm (e.g., used to find the best PMI codewords, as described in connection with FIG. 4).

The sequence of bits may encode a CSI report that indicates the compressed representation, and the network node 110 may receive the CSI report. Accordingly, the network node 110 may apply the decoder 557 to generate a reconstructed precoder (e.g., represented by V*) from the compressed representation. Accordingly, the decoder is analogous to a PMI codebook (e.g., used to translate CSI reporting bits to a PMI codeword, as described in connection with FIG. 4). In some aspects, the decoder 557 may output could be a (reconstructed) downlink channel matrix 559 (corresponding to a raw channel or a channel pre-whitened by the UE 120 based on a demodulation filter of the UE 120). Similarly, the decoder 557 may output an interference covariance matrix (e.g., represented by Rₙₙ) or a transmit covariance matrix. In example 550, the decoder 557 may output a (reconstructed) downlink precoder 559. The network node 110 may therefore schedule a downlink transmission based on reconstructed CSI (e.g., the reconstructed downlink channel matrix or downlink precoder 559).

As indicated above, FIGS. 5A and 5B are provided as examples. Other examples may differ from what is described with respect to FIGS. 5A and 5B.

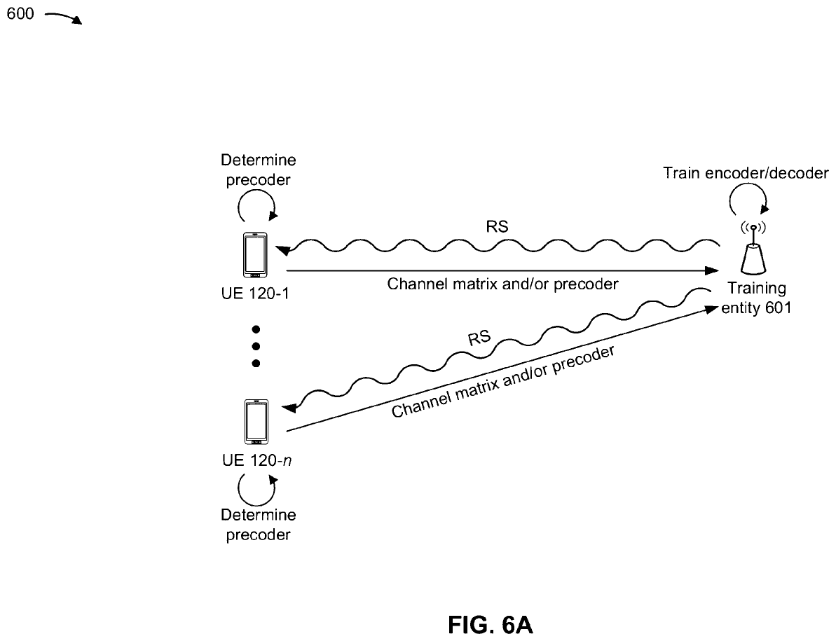

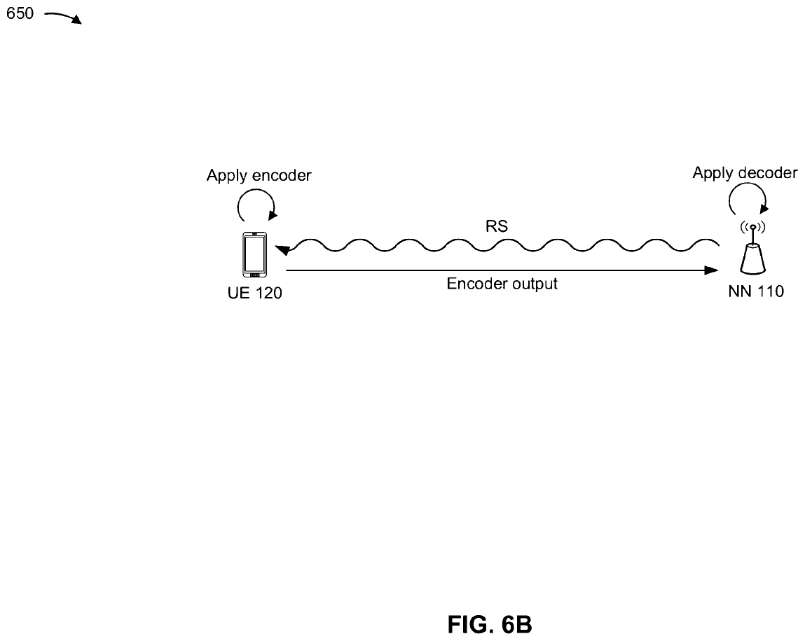

FIG. 6A is a diagram illustrating an example 600 of a data collection phase and a training phase for an encoder and a decoder, in accordance with the present disclosure. In order to train an encoder (e.g., encoder 555, as described in connection with FIG. 5B) and a corresponding decoder (e.g., decoder 557, as described in connection with FIG. 5B), an network node 110 may perform data collection using multiple UEs (e.g., UE 120-1, . . . , UE 120-n in example 600, where n represents a quantity of UEs used for data collection).

As shown in FIG. 6A, the network node 110 may transmit RSs to the UEs for measurement. During a training phase, the UEs may determine precoders (e.g., using SVD algorithms) based on measurements of the RSs and may report the precoders to the network node 110. Additionally, in some aspects, the UEs may report channel matrices representing measurements of the RSs to the network node 110. Therefore, the network node 110 (or a training entity 601 associated with the network node 110) may train the encoder and the corresponding decoder based on the precoders (and, in some aspects, the channel matrices). Example 600 is an example of centralized training at a network. Other examples may include the UE 120 and the network node 110 (or training entities associated with the UE 120 and the network node 110) training the encoder and the decoder in a same training session, as described above. Alternatively, other examples may include the UE 120 and the network node 110 (or training entities associated with the UE 120 and the network node 110) training the encoder and the decoder sequentially. As described above, either UE-first training or network-first training may be used.

Based on the training, the network node 110 may provide a trained encoder to multiple UEs in order to refine the trained encoder (e.g., during a refinement phase). The UEs may be the same set of UEs as used during the training phase or may include at least one different UE. The network node 110 may again transmit RSs to the UEs for measurement. During the refinement phase, the UEs may determine precoders (e.g., using SVD algorithms) based on measurements of the RSs and may report compressed representations of the precoders output by the trained encoder to the network node 110. Additionally, in some aspects, the UEs may report the precoders to the network node 110. Therefore, the network node 110 may refine the encoder and the corresponding decoder based on the compressed representations (and, in some aspects, the precoders).

FIG. 6B is a diagram illustrating an example 650 of an inference for an encoder and a decoder, in accordance with the present disclosure. In example 650, a UE 120 and a network node 110 may use an encoder (e.g., encoder 555, as described in connection with FIG. 5B) and a corresponding decoder (e.g., decoder 557, as described in connection with FIG. 5B) for channel state feedback (CSF). In one example, the network node 110 may indicate the encoder to the UE 120 to use, or the UE 120 may be programmed (and/or otherwise preconfigured) with the encoder to use. In another example, a training entity of the UE 120 may train the encoder 707 that the UE 120 uses. As shown in FIG. 6B, the network node 110 may transmit an RS to the UE 120 for measurement. During an inference phase, the UE 120 may apply the encoder (e.g., as described in connection with FIG. 5B) to a precoder determined based on a measurement of the RS. Accordingly, the UE 120 may report output from the encoder (e.g., a compressed representation of the precoder) to the network node 110. The network node 110 may apply the decoder (e.g., as described in connection with FIG. 5B) and schedule a downlink transmission based on output from the decoder (e.g., a reconstructed channel matrix or precoder).

Training an encoder and a corresponding decoder may be hardware dependent. In practice, data corresponding to different types of devices may have different characteristics. For example, the source of such differences may result from device construction, RF aspects, or implementation differences across vendors, device models, and/or chipsets, among other examples. However, in order to conserve power, processing resources, and memory usage, training data may be obtained from one type of device to develop models (e.g., encoders and decoders). Accordingly, when such models are used for inference on another type of device, discrepancies in data distribution between training and inference may impact the performance of the models.

One example discrepancy is associated with SVD. In calculating an input CSI or a target CSI (e.g., during a data collection phase), a UE may calculate the SVD of a channel measurement on each subband. However, different UEs may use different SVD algorithms, and different SVD algorithm result in different phase rotations on resultant precoders associated with each subband. For example, a precoder on subband k may be calculated by

$${V}_{k} = SVD ( {\sum }_{n = 1}^{{SB}_{size}} {H}_{k , n} * {H}_{k , n}^{H} ) ,$$

where H_{k,n} represents a channel measurement associated with the n^{th} resource block (RB) of subband k. A size of H_{k,n} may be Nₜ×Nᵣ, where Nₜ represents a quantity of antenna ports, and Nᵣ represents a quantity of subcarriers. A size of Vₖ may be Nₜ×rank. A precoder (represented by V_{k,alg1}) calculated using a first SVD algorithm may differ in phase from a precoder (represented by V_{k,alg2}) calculated using a second SVD algorithm, such that V_{k,alg1}=V_{k,alg2}*diag{e^{jθ}^{_{k,1}}, e^{jθ}^{_{k,2}}, e^{jθ}^{_{k,3}}, e^{jθ}^{_{k,4}}}, where θ_{k,l} represents a phase rotation on layer l and subband k. As a result, when the UE applies a different SVD algorithm than was used during training of the encoder (and the corresponding decoder), accuracy of output from the decoder at a network is decreased, which reduces quality and reliability of communications between the UE and the network. Reduced quality and reliability wastes power and processing resources because the network generally performs more re-transmissions to the UE.

Some techniques and apparatuses described herein enable a UE (e.g., UE 120) to apply phase alignment to a precoder before reporting and/or using the precoder. For example, the UE 120 may apply a phase alignment algorithm to a precoder represented by Vₖ, where k=1, . . . , N_{SB} such that Vₖ calculated by different SVD algorithms have (at least approximately) a same phase rotation. As a result, accuracy of training (and refinement) using the precoder is improved. Similarly, accuracy of a reconstructed precoder at a network based on a compressed representation of the precoder is improved. Improved accuracy results in improved quality and reliability of communications between the UE 120 and the network, which conserves power and processing resources because the network generally performs fewer re-transmissions to the UE 120. Alternatively, the UE 120 may apply phase alignment to the precoder before performing frequency compression on the precoder to select codewords (and thus select a PMI). As a result, the UE 120 conserves power, processing resources, and memory usage because the phase alignment reduces computational overhead associated with the frequency compression.

As indicated above, FIGS. 6A and 6B are provided as an example. Other examples may differ from what is described with respect to FIGS. 6A and 6B.

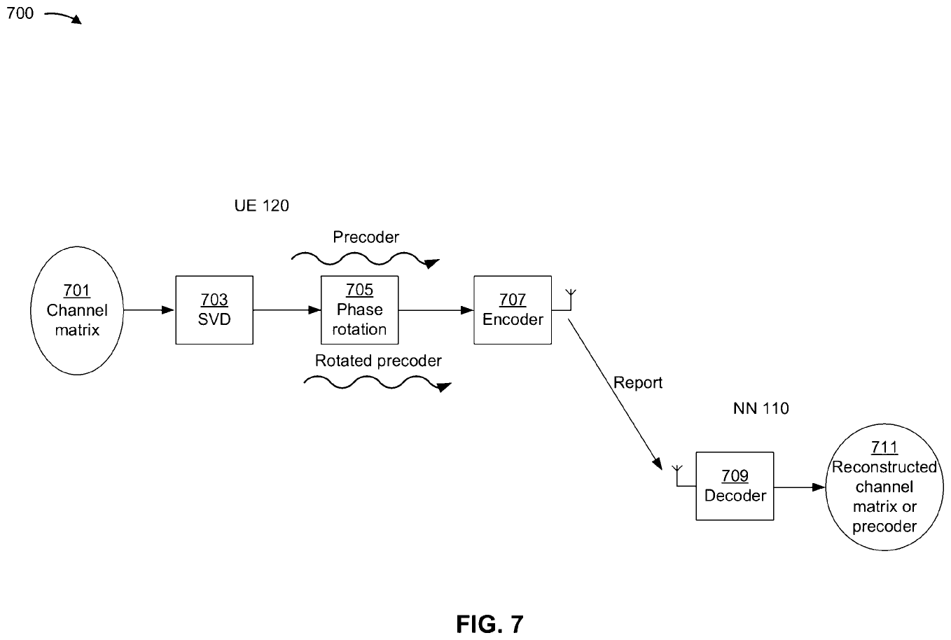

FIG. 7 is a diagram illustrating an example 700 associated with applying phase alignment for precoders, in accordance with the present disclosure. In example 700, a UE 120 and a network node 110 may use an encoder (e.g., encoder 707) and a corresponding decoder (e.g., decoder 709) for CSF. In one example, the network node 110 may indicate the encoder 707 to the UE 120 to use, or the UE 120 may be programmed (and/or otherwise preconfigured) with the encoder 707 to use. In another example, a training entity of the UE 120 may train the encoder 707 that the UE 120 uses.

The network node 110 may transmit an RS to the UE 120 for measurement. Accordingly, the UE 120 may perform a measurement on the RS (e.g., a channel matrix 701). In order to determine a precoding matrix (also referred to as a “precoder”) based on the measurement, the UE 120 may apply SVD (e.g., an SVD algorithm 703).

As further shown in FIG. 7, the UE 120 may apply a phase rotation 705 to the precoding matrix to generate a rotated precoding matrix. In one example, the phase rotation 705 is applied per subband and per layer and is determined based on a phase of a first entry in the precoding matrix associated with a corresponding subband and layer. Mathematically, a portion of the precoding matrix may be represented by V_{k,l} (e.g., having a size Nₜ×1), which thus represents a precoding vector for layer l on subband k. Accordingly, the phase rotation 705 is θ_{k,l}=−angle(V_{k,l} [1]), where V_{k,l} [1]=a*exp (jψ) and represents a first entry in V_{k,l} (e.g., a weight applied to a first antenna port on subband k and layer l) and entries in V_{k,l} are indexed by 1, 2, . . . , Nₜ. Accordingly, the phase rotation 705 is θ_{k,l}=−ψ.

In another example, the phase rotation 705 is applied per layer and is determined based on a frequency correlation aggregated across weights applied to antenna ports. Mathematically, the UE 120 may formulate a precoding matrix V̅ₗ=[V_{1,l} V_{2,l}, . . . . V_{N}_{_{SB}}_{,l}] (e.g., having a size Nₜ×N_{SB}) by aggregating precoder vectors on all subbands for layer l. The UE 120 may further calculate

$${R}_{f , l} = {\overline{V}}_{l}^{H} \times {\overline{V}}_{l} = {\sum }_{i = 1}^{{N}_{t}} {{\overline{V}}_{l} [ i , : ]}^{II} \times {\overline{V}}_{l} [ i , : ] ,$$

where V̅ₗ[i,:] represents the i-th row of V̅ₗ (e.g., including weights applied to antenna port i across all subbands), and R_{f} represents the frequency correlation for layer l. Accordingly, the UE 120 may calculate the right singular matrix Uₗ=SVD(R_{f,l}) such that the phase rotation 705 applied for subband k is given by the phase of a k^{th} entry of a first column of Uₗ, that is, Uₗ[k, 1], and θ_{k,l}=angle(Uₗ[k, 1]).

In another example, the phase rotation 705 is determined such that the rotated precoding matrix across subbands yields a reduced delay (e.g., delay spread and/or average delay). Mathematically, Wₗ(θₗ)=[V_{1,l}·e^{jθ}^{_{1,l}} V_{2,l}·e^{jθ}^{_{1,l}} . . . V_{N}_{_{SB}}_{,l}·e^{jθN}^{_{SB}}^{,l}] (e.g., having a size Nₜ×N_{SB}) that aggregates precoding vectors on all subbands for layer l after applying the phase rotation 705 on each subband. Further, the UE 120 may apply an inverse fast Fourier transform (IFFT) such that W_{l,t}(θₗ)=IFFT(Wₗ(θₗ))=Wₗ(θₗ)×F^{H} represents a rotated precoding matrix in a transformed domain (e.g., a delay domain), where F represents a discrete Fourier transform (DFT) matrix, and F^{H} represents an inverse discrete Fourier transform (IDFT) matrix. The size of W_{l,t}(θₗ) may be Nₜ×N_{SB}. Accordingly, the UE 120 may determine the phase rotation 705 (e.g., represented by [θ_{1,l}, . . . , θ_{N}_{_{SB}}_{,l}]) such that

$${θ}_{l} = min {\sum }_{i = 1}^{{N}_{t}} \frac{{\sum }_{d = 1}^{{N}_{S B}} {\vert {w}_{l , t} ( {θ}_{l} ) [ i , d ] \vert}^{2} \cdot d}{{\sum }_{d = 1}^{{N}_{SB}} d} .$$

Accordingly, UE 120 may apply a minimization function to the delay such that the phase rotation 705 results in at least local minimum delay.

The UE 120 may select between different phase alignment algorithms, as described above, based on a preconfigured setting stored in a memory of (and/or otherwise programmed into) the UE 120. Alternatively, the network node 110 may configure the UE 120 to apply one of the phase alignment algorithms described above. Alternatively, the UE 120 may select one of the phase alignment algorithms described above and report the selected phase alignment algorithm to the network node 110 (e.g., during a data collection phase, as described in connection with FIG. 6A).

As further shown in FIG. 7, the UE 120 may apply the encoder 707 to the rotated precoding matrix. Accordingly, the UE 120 may report output from the encoder (e.g., a compressed representation of the rotated precoding matrix) to the network node 110. The network node 110 may apply the decoder 709 and configure a channel between the UE 120 and the network node 110 based on output from the decoder 709 (e.g., a reconstructed channel matrix or precoder 711).

By using techniques as described in connection with FIG. 7, accuracy of training (and refinement) using the precoder is improved. Similarly, accuracy of the reconstructed precoder at the network node 110 based on the compressed representation of the precoder is improved. Improved accuracy results in improved quality and reliability of communications between the UE 120 and the network node 110, which conserves power and processing resources because the network node 110 generally performs fewer re-transmissions to the UE 120. Alternatively, the UE 120 may apply phase rotation 705 to the precoder before performing frequency compression on the precoder to select codewords (and thus select a PMI). As a result, the UE 120 conserves power, processing resources, and memory usage because the phase rotation 705 reduces computational overhead associated with the frequency compression.

As indicated above, FIG. 7 is provided as an example. Other examples may differ from what is described with respect to FIG. 7.

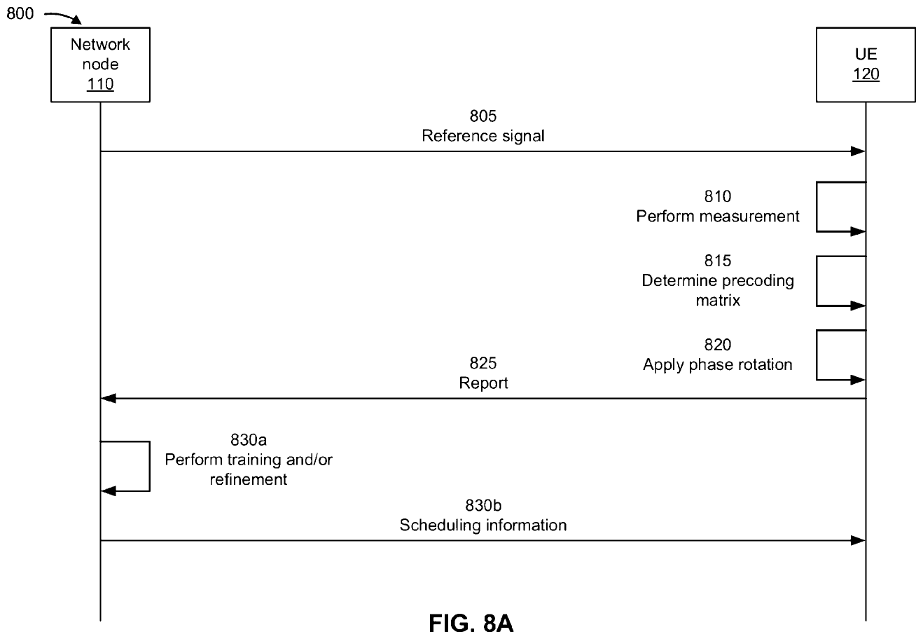

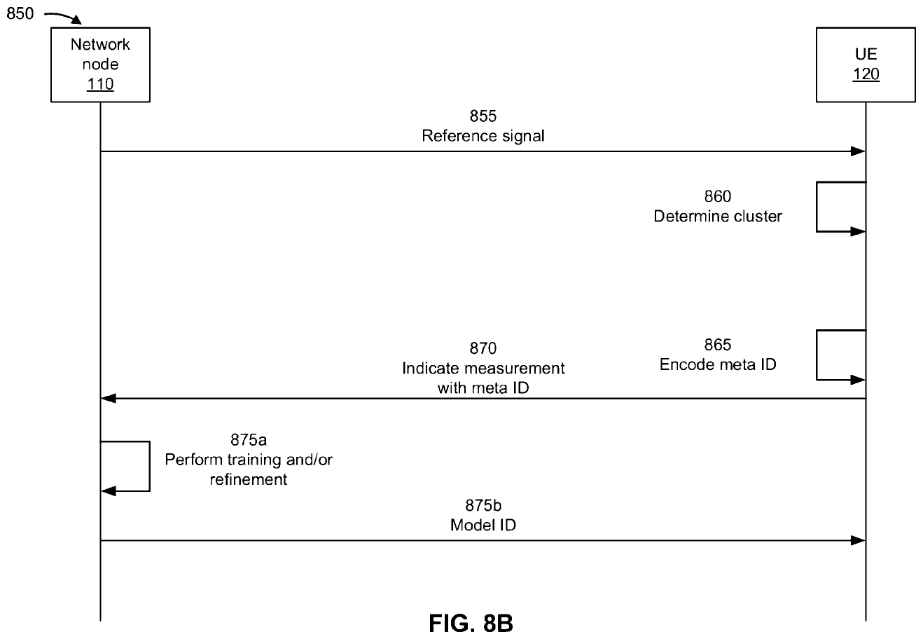

FIG. 8A is a diagram illustrating an example 800 associated with applying phase alignment for precoders, in accordance with the present disclosure. As shown in FIG. 8A, a network node 110 (e.g., an RU 340 and/or a device controlling the RU 340, such as a DU 330 and/or a CU 310) and a UE 120 may communicate with one another (e.g., on a wireless network, such as wireless network 100 of FIG. 1).

As shown by reference number 805, the network node 110 may transmit (e.g., directly or via the RU 340), and the UE 120 may receive, an RS. For example, the RS may include a CSI-RS for channel measurement, a CSI interference measurement (CSI-IM) or non-zero-power (NZP) CSI-RS for interference measurement, or a combination of two or more of a CSI-RS for channel measurement, a CSI-IM, and a NZP CSI-RS for interference measurement.

As shown by reference number 810, the UE 120 may perform a measurement on the RS. For example, the UE 120 may calculate a channel matrix based on the RS.

As shown by reference number 815, the UE 120 may determine a transmission precoding matrix based on the measurement. The transmission precoding matrix may include a sub-matrix (or a vector) for each subband. The UE 120 may apply a first SVD algorithm to determine the transmission precoding matrix.

As shown by reference number 820, the UE 120 may apply a phase rotation to the transmission precoding matrix. Accordingly, the UE 120 may generate a rotated precoding matrix. In some aspects, a portion of the rotated precoding matrix associated with a first subband is associated with a first phase rotation and a portion of the rotated precoding matrix associated with a second subband is associated with a second phase rotation. Thus, the phase rotation may be different across subbands. Additionally, or alternatively, a portion of the rotated precoding matrix associated with a first layer is associated with a first phase rotation and a portion of the rotated precoding matrix associated with a second layer is associated with a second phase rotation. Thus, the phase rotation may be different across layers.

In some aspects, as described in connection with FIG. 7, the UE 120 may select a phase of a first entry in the precoding matrix (e.g., per layer and/or per subband) as a phase multiplier and apply the phase multiplier to remaining entries (e.g., per layer and/or per subband) in the precoding matrix. Alternatively, as described in connection with FIG. 7, the UE 120 may determine a matrix of frequency correlations (e.g., per layer) aggregated across weights associated with one or more antenna ports, apply SVD to the matrix of frequency correlations to generate an eigenvector (e.g., per layer), and apply a phase multiplier associated (e.g., per subband) indicated in the eigenvector to entries in the precoding matrix (e.g., per layer and/or per subband). Alternatively, as described in connection with FIG. 7, the UE 120 may determine a delay associated with the precoding matrix using an IFFT and apply a set of phase multipliers to the precoding matrix based on applying a minimization function to the delay.

As shown by reference number 825, the UE 120 may transmit, and the network node 110 may receive (e.g., directly or via the RU 340) a report based at least in part on the rotated precoding matrix. In some aspects, the report may indicate the rotated precoding matrix. Accordingly, the UE 120 may report the rotated precoding matrix as a target CSI or an input CSI (e.g., during a data collection phase). Accordingly, as shown by reference number 830a, the network node 110 may perform training (e.g., during a training phase) of an encoder (and a corresponding decoder) using the rotated precoding matrix. Additionally, or alternatively, as further shown by reference number 830a, the network node 110 may perform refinement (e.g., during a refinement phase) of the encoder (and the corresponding decoder) using the rotated precoding matrix. Although example 800 includes the network node 110 (or a training entity at the network node 110) performing training and/or refinement, other examples may include the UE 120 (or a training entity at the UE 120) performing training and/or refinement, as described above. Accordingly, the UE 120 may report the rotated precoding matrix as a target CSI or an input CSI to the training entity at the UE 120. Accuracy of the training and/or refinement is improved by using the rotated precoding matrix in lieu of the precoding matrix.

Alternatively, the UE 120 may use the rotated precoding matrix as input to an encoder (e.g., during an inference phase). Accordingly, the report may indicate output from the encoder (e.g., a machine learning model that accepts the rotated precoding matrix as input). Accordingly, as shown by reference number 830b, the network node 110 may transmit (e.g., directly or via the RU 340), and the UE 120 may receive, downlink scheduling information based on the rotated precoding matrix. Even when the network node 110 uses a decoder trained using data from the second SVD algorithm, the scheduling information results in improved quality and reliability of communications when the UE 120 transmits output based on the rotated precoding matrix in lieu output based on the precoding matrix.

Alternatively, the UE 120 may report a CSI based on the rotated precoding matrix. Accordingly, the report may indicate a PMI (e.g., based on a legacy non-AI codebook, as described above) selected using the rotated precoding matrix (e.g., based on best codewords identifier using the rotated precoding matrix). Accordingly, as shown by reference number 830b, the network node 110 may transmit (e.g., directly or via the RU 340), and the UE 120 may receive, downlink scheduling information based on the PMI.

FIG. 8B is a diagram illustrating an example 850 associated with reporting using a meta indicator, in accordance with the present disclosure. As shown in FIG. 8B, a network node 110 (e.g., an RU 340 and/or a device controlling the RU 340, such as a DU 330 and/or a CU 310) and a UE 120 may communicate with one another (e.g., on a wireless network, such as wireless network 100 of FIG. 1).

As shown by reference number 855, the network node 110 may transmit (e.g., directly or via the RU 340), and the UE 120 may receive, an RS. For example, the RS may include a CSI-RS for channel measurement, a CSI-IM or NZP CSI-RS for interference measurement, or a combination of two or more of a CSI-RS for channel measurement, a CSI-IM, and a NZP CSI-RS for interference measurement.

Accordingly, the UE 120 may perform a measurement on the RS. For example, the UE 120 may calculate a channel matrix based on the RS. The UE 120 may perform the measurement as part of a data collection phase (e.g., as described in connection with FIG. 6A).

As shown by reference number 860, the UE 120 may determine a cluster associated with the UE 120. For example, the UE 120 may determine the cluster out of a plurality of possible clusters. Each cluster may be associated with a set of reception properties of UEs included in the cluster. For example, the cluster may be associated with a set of precoders, a set of antenna configurations (e.g., a range of antenna elements and/or a set of shapes for the antenna elements), a set of beamforming configurations, a set of phase rotation algorithms, and/or a set of SVD algorithms. Therefore, the UE 120 may determine the cluster by mapping reception properties associated with the UE 120 to the set of reception properties associated with the cluster.

In some aspects, the network node 110 may transmit an indication of the plurality of possible clusters as well as the set of reception properties associated with each possible cluster. Additionally, or alternatively, an indication of the plurality of possible clusters, as well as the set of reception properties associated with each possible cluster, may be stored in a memory of (and/or otherwise programmed into) the UE 120. Therefore, the UE 120 may determine in which cluster the UE 120 belongs.

As shown by reference number 865, the UE 120 may encode a meta indicator (also referred to as a “meta ID”) in an indication to be transmitted to the network node 110. For example, each cluster may be associated with a corresponding meta indicator. Therefore, the UE 120 may use the meta indicator associated with the cluster that includes the UE 120. The meta indicator may include an alphanumeric indicator, and the UE 120 may select the meta indicator from a plurality of possible indicators. For example, the plurality of possible indicators may correspond to the plurality of possible clusters, such that the UE 120 selects the meta indicator based on the reception properties associated with the UE 120.

In some aspects, the network node 110 may transmit an indication of the plurality of possible indicators as well as the set of reception properties associated with each possible indicator. Additionally, or alternatively, an indication of the plurality of possible indicators, as well as the set of reception properties associated with each of the possible indicators, may be stored in a memory of (and/or otherwise programmed into) the UE 120. Therefore, the UE 120 may encode the meta indicator that corresponds to the cluster in which the UE 120 belongs.

As shown by reference number 870, the UE 120 may transmit, and the network node 110 may receive (e.g., directly or via the RU 340), an indication of the measurement of the reference signal with the meta indicator. The measurement may function as a target CSI or an input CSI (e.g., during a data collection phase). Additionally, the meta indicator allows the UE 120 to inform the network node 110 about the reception properties of the UE 120 without expressly indicating the reception properties. For example, the network node 110 may infer estimates of the reception properties based on the cluster corresponding to the meta indicator without inferring exact values for the reception properties. As a result, privacy for the UE 120 is preserved.

In some implementations, as shown by reference number 875a, the network node 110 may perform training (e.g., during a training phase) of an encoder (and a corresponding decoder) using the measurement and the meta indicator. Additionally, or alternatively, as further shown by reference number 875a, the network node 110 may perform refinement (e.g., during a refinement phase) of the encoder (and the corresponding decoder) using the measurement and the meta indicator. Although example 850 includes the network node 110 (or a training entity at the network node 110) performing training and/or refinement, other examples may include the UE 120 (or a training entity at the UE 120) performing training and/or refinement, as described above. Accordingly, the UE 120 may report the measurement as a target CSI or an input CSI to the training entity at the UE 120.

In some implementations, the UE 120 may proceed from the data collection phase to an inference phase. Accordingly, as shown by reference number 875b, the network node 110 may transmit (e.g., directly or via the RU 340), and the UE 120 may receive, a model indicator in response to the meta indicator. For example, the network node 110 may map the meta indicator to a model indicator (out of a plurality of possible model indicators) associated with an encoder-decoder pair (out of a plurality of possible encoder-decoder pairs). Therefore, the network node 110 may indicate the encoder-decoder pair for the UE 120 to use that is best suited to the reception properties of the UE 120 as represented by the meta indicator. Therefore, the network node 110 and the UE 120 improve accuracy of outputs from the encoder-decoder pair without the UE 120 reporting exact values for the reception properties of the UE 120. As a result, privacy for the UE 120 is preserved.

As indicated above, FIGS. 8A-8B are provided as examples. Other examples may differ from what is described with respect to FIGS. 8A-8B.

FIG. 9 is a diagram illustrating an example process 900 performed, for example, by a UE, in accordance with the present disclosure. Example process 900 is an example where the UE (e.g., UE 120 and/or apparatus 1300 of FIG. 13) performs operations associated with applying phase alignment for precoders.

As shown in FIG. 9, in some aspects, process 900 may include performing a measurement on a reference signal (block 910). For example, the UE (e.g., using communication manager 140 and/or measurement component 1308, depicted in FIG. 13) may perform a measurement on a reference signal, as described herein.

As further shown in FIG. 9, in some aspects, process 900 may include determining a precoding matrix based on the measurement (block 920). For example, the UE (e.g., using communication manager 140 and/or determination component 1310, depicted in FIG. 13) may determine a precoding matrix based on the measurement, as described herein.

As further shown in FIG. 9, in some aspects, process 900 may include applying a phase rotation to the precoding matrix to generate a rotated precoding matrix (block 930). For example, the UE (e.g., using communication manager 140 and/or determination component 1310) may apply a phase rotation to the precoding matrix to generate a rotated precoding matrix, as described herein.

As further shown in FIG. 9, in some aspects, process 900 may include transmitting a report based at least in part on the rotated precoding matrix (block 940). For example, the UE (e.g., using communication manager 140 and/or transmission component 1304, depicted in FIG. 13) may transmit a report based at least in part on the rotated precoding matrix, as described herein.

Process 900 may include additional aspects, such as any single aspect or any combination of aspects described below and/or in connection with one or more other processes described elsewhere herein.

In a first aspect, the reference signal includes a CSI-RS.

In a second aspect, alone or in combination with the first aspect, the measurement includes a channel matrix.

In a third aspect, alone or in combination with one or more of the first and second aspects, determining the precoding matrix includes applying SVD to a matrix representing the measurement to determine the precoding matrix.

In a fourth aspect, alone or in combination with one or more of the first through third aspects, applying the phase rotation includes selecting a phase of a first entry in the precoding matrix associated with a first layer and a first subband as a first phase multiplier and applying the first phase multiplier to remaining entries associated with the first layer and the first subband in the precoding matrix.

In a fifth aspect, alone or in combination with one or more of the first through fourth aspects, applying the phase rotation further includes selecting a phase of a first entry in the precoding matrix associated with the first layer and a second subband as a second phase multiplier and applying the second phase multiplier to remaining entries associated with the first layer and the second subband in the precoding matrix.

In a sixth aspect, alone or in combination with one or more of the first through fifth aspects, applying the phase rotation further includes selecting a phase of a first entry in the precoding matrix associated with a second layer and the first subband as a second phase multiplier and applying the second phase multiplier to remaining entries associated with the second layer and the first subband in the precoding matrix.

In a seventh aspect, alone or in combination with one or more of the first through sixth aspects, applying the phase rotation includes determining a matrix of frequency correlations associated with a first layer aggregated across weights associated with one or more antenna ports, applying SVD to the matrix of frequency correlations to generate an eigenvector associated with the first layer, and applying a phase multiplier associated with a first subband and indicated in the eigenvector to entries in the precoding matrix associated with the first layer and the first subband.

In an eighth aspect, alone or in combination with one or more of the first through seventh aspects, applying the phase rotation further includes applying phase multipliers associated with a second subband and indicated in the eigenvector to entries in the precoding matrix associated with the first layer and the second subband.

In a ninth aspect, alone or in combination with one or more of the first through eighth aspects, applying the phase rotation further includes determining an additional matrix of frequency correlations associated with a second layer aggregated across additional weights associated with the one or more antenna ports, applying SVD to the additional matrix of frequency correlations to generate an additional eigenvector associated with the second layer, and applying a phase multiplier indicated in the additional eigenvector to entries in the precoding matrix associated with the second layer and the first subband.

In a tenth aspect, alone or in combination with one or more of the first through ninth aspects, applying the phase rotation includes determining a delay associated with the precoding matrix using an IFFT and applying a set of phase multipliers to the precoding matrix based on applying a minimization function to the delay.

In an eleventh aspect, alone or in combination with one or more of the first through tenth aspects, the report indicates the rotated precoding matrix.

In a twelfth aspect, alone or in combination with one or more of the first through eleventh aspects, the report indicates output from a machine learning model that accepts the rotated precoding matrix as input.

In a thirteenth aspect, alone or in combination with one or more of the first through twelfth aspects, the report indicates at least one PMI selected using the rotated precoding matrix.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a network node, in accordance with the present disclosure. Example process 1000 is an example where the network node (e.g., network node 110 and/or apparatus 1600 of FIG. 16) performs operations associated with decoding phase aligned precoders.

As shown in FIG. 10, in some aspects, process 1000 may include transmitting a reference signal (block 1010). For example, the network node (e.g., using communication manager 150 and/or transmission component 1604, depicted in FIG. 16) may transmit a reference signal, as described herein.

As further shown in FIG. 10, in some aspects, process 1000 may include receiving a report based at least in part on a rotated precoding matrix based on a first SVD algorithm and a measurement of the reference signal (block 1020). For example, the network node (e.g., using communication manager 150 and/or reception component 1602, depicted in FIG. 16) may receive a report based at least in part on a rotated precoding matrix based on a first SVD algorithm and a measurement of the reference signal, as described herein.

As further shown in FIG. 10, in some aspects, process 1000 may include receiving output from a decoder trained on output from a second SVD algorithm and accepting input from the report (block 1030). For example, the network node (e.g., using communication manager 150 and/or reception component 1602) may receive output from a decoder trained on output from a second SVD algorithm and accepting input from the report, as described herein.

Process 1000 may include additional aspects, such as any single aspect or any combination of aspects described below and/or in connection with one or more other processes described elsewhere herein.

In a first aspect, the reference signal includes a CSI-RS.

In a second aspect, alone or in combination with the first aspect, the measurement includes a channel matrix.

In a third aspect, alone or in combination with one or more of the first and second aspects, a phase of a first entry in the rotated precoding matrix is zero.

In a fourth aspect, alone or in combination with one or more of the first through third aspects, a portion of the rotated precoding matrix associated with a first subband is associated with a first phase rotation, and a portion of the rotated precoding matrix associated with a second subband is associated with a second phase rotation.

In a fifth aspect, alone or in combination with one or more of the first through fourth aspects, a portion of the rotated precoding matrix associated with a first layer is associated with a first phase rotation, and a portion of the rotated precoding matrix associated with a second layer is associated with a second phase rotation.

In a sixth aspect, alone or in combination with one or more of the first through fifth aspects, the report indicates the rotated precoding matrix.

In a seventh aspect, alone or in combination with one or more of the first through sixth aspects, process 1000 includes training (e.g., using communication manager 150 and/or training component 1608, depicted in FIG. 16) a machine learning model based at least in part on the rotated precoding matrix.

In an eighth aspect, alone or in combination with one or more of the first through seventh aspects, the report indicates output from a machine learning model that accepts the rotated precoding matrix as input.

In a ninth aspect, alone or in combination with one or more of the first through eighth aspects, process 1000 includes refining (e.g., using communication manager 150 and/or refinement component 1610, depicted in FIG. 16) the machine learning model based at least in part on the output.

In a tenth aspect, alone or in combination with one or more of the first through ninth aspects, process 1000 includes applying a decoder (e.g., using communication manager 150 and/or decoder component 1612, depicted in FIG. 16) to the output to determine a reconstructed precoding matrix and transmitting (e.g., using communication manager 150 and/or transmission component 1604) downlink scheduling information based on the reconstructed precoding matrix.

In an eleventh aspect, alone or in combination with one or more of the first through tenth aspects, the report indicates at least one PMI based on the rotated precoding matrix.

In a twelfth aspect, alone or in combination with one or more of the first through eleventh aspects, process 1000 includes transmitting (e.g., using communication manager 150 and/or transmission component 1604) downlink scheduling information based on the at least one PMI.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, by a UE, in accordance with the present disclosure. Example process 1100 is an example where the UE (e.g., UE 120 and/or apparatus 1300 of FIG. 13) performs operations associated with reporting using a meta indicator.

As shown in FIG. 11, in some aspects, process 1100 may include performing a measurement on a reference signal (block 1110). For example, the UE (e.g., using communication manager 140 and/or measurement component 1308, depicted in FIG. 13) may perform a measurement on a reference signal, as described herein.

As further shown in FIG. 11, in some aspects, process 1100 may include transmitting a meta indicator representing one or more properties associated with processing of the reference signal at the UE (block 1120). For example, the UE (e.g., using communication manager 140 and/or transmission component 1304, depicted in FIG. 13) may transmit a meta indicator representing one or more properties associated with processing of the reference signal at the UE, as described herein.

Process 1100 may include additional aspects, such as any single aspect or any combination of aspects described below and/or in connection with one or more other processes described elsewhere herein.

In a first aspect, the meta indicator includes an alphanumeric indicator selected from a plurality of possible indicators using the one or more properties.

In a second aspect, alone or in combination with the first aspect, the meta indicator is associated with a cluster of UEs, from a plurality of possible clusters, that includes the UE.

In a third aspect, alone or in combination with one or more of the first and second aspects, the measurement is performed as part of a data collection phase.

In a fourth aspect, alone or in combination with one or more of the first through third aspects, the one or more properties include a precoder applied by the UE, an antenna configuration associated with the UE, a beamforming configuration used by the UE, a phase rotation algorithm applied by the UE, or a singular value decomposition algorithm applied by the UE.

In a fifth aspect, alone or in combination with one or more of the first through fourth aspects, process 1100 includes receiving (e.g., using communication manager 140 and/or reception component 1302, depicted in FIG. 13) a model indicator in response to transmission of the meta indicator.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, by a network node, in accordance with the present disclosure. Example process 1000 is an example where the network node (e.g., network node 110 and/or apparatus 1600 of FIG. 16) performs operations associated with reporting using a meta indicator.

As shown in FIG. 12, in some aspects, process 1200 may include transmitting a reference signal (block 1210). For example, the network node (e.g., using communication manager 150 and/or transmission component 1604, depicted in FIG. 16) may transmit a reference signal, as described herein.

As further shown in FIG. 12, in some aspects, process 1200 may include receiving a meta indicator representing one or more properties associated with processing of the reference signal at a UE (e.g., UE 120 and/or apparatus 1300 of FIG. 13) (block 1220). For example, the network node (e.g., using communication manager 150 and/or reception component 1602, depicted in FIG. 16) may receive a meta indicator representing one or more properties associated with processing of the reference signal at a UE, as described herein.

Process 1200 may include additional aspects, such as any single aspect or any combination of aspects described below and/or in connection with one or more other processes described elsewhere herein.

In a first aspect, the meta indicator includes an alphanumeric indicator selected from a plurality of possible indicators using the one or more properties.

In a second aspect, alone or in combination with the first aspect, the meta indicator is associated with a cluster of UEs, from a plurality of possible clusters, that includes the UE.

In a third aspect, alone or in combination with one or more of the first and second aspects, the reference signal is transmitted as part of a data collection phase.

In a fourth aspect, alone or in combination with one or more of the first through third aspects, the one or more properties include a precoder applied by the UE, an antenna configuration associated with the UE, a beamforming configuration used by the UE, a phase rotation algorithm applied by the UE, or a singular value decomposition algorithm applied by the UE.

In a fifth aspect, alone or in combination with one or more of the first through fourth aspects, process 1200 includes transmitting (e.g., using communication manager 150 and/or transmission component 1604) a model indicator in response to reception of the meta indicator.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram of an example apparatus 1300 for wireless communication, in accordance with the present disclosure. The apparatus 1300 may be a UE, or a UE may include the apparatus 1300. In some aspects, the apparatus 1300 includes a reception component 1302 and a transmission component 1304, which may be in communication with one another (for example, via one or more buses and/or one or more other components). As shown, the apparatus 1300 may communicate with another apparatus 1306 (such as a UE, an RU, or another wireless communication device) using the reception component 1302 and the transmission component 1304. As further shown, the apparatus 1300 may include the communication manager 140. The communication manager 140 may include one or more of a measurement component 1308 and/or a determination component 1310, among other examples.

In some aspects, the apparatus 1300 may be configured to perform one or more operations described herein in connection with FIGS. 7, 8A, and/or 8B. Additionally, or alternatively, the apparatus 1300 may be configured to perform one or more processes described herein, such as process 900 of FIG. 9, process 1100 of FIG. 11, or a combination thereof. In some aspects, the apparatus 1300 and/or one or more components shown in FIG. 13 may include one or more components of the UE described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1306. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, a modem, a demodulator, a MIMO detector, a receive processor, a controller/processor, a memory, or a combination thereof, of the UE described in connection with FIG. 2.

The transmission component 1304 may transmit communications, such as reference signals, control information, data communications, or a combination thereof, to the apparatus 1306. In some aspects, one or more other components of the apparatus 1300 may generate communications and may provide the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modem, a modulator, a transmit MIMO processor, a transmit processor, a controller/processor, a memory, or a combination thereof, of the UE described in connection with FIG. 2. In some aspects, the transmission component 1304 may be co-located with the reception component 1302 in a transceiver.

In some aspects, the measurement component 1308 may perform a measurement on a reference signal. Accordingly, the determination component 1310 may determine a precoding matrix based on the measurement. The determination component 1310 may further apply a phase rotation to the precoding matrix to generate a rotated precoding matrix. Accordingly, the transmission component 1304 may transmit a report based at least in part on the rotated precoding matrix.

Additionally, or alternatively, the measurement component 1308 may perform a measurement on a reference signal. Accordingly, the transmission component 1304 may transmit a meta indicator representing one or more properties associated with the reception component 1302 (e.g., associated with processing of the reference signal at the apparatus 1300).

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

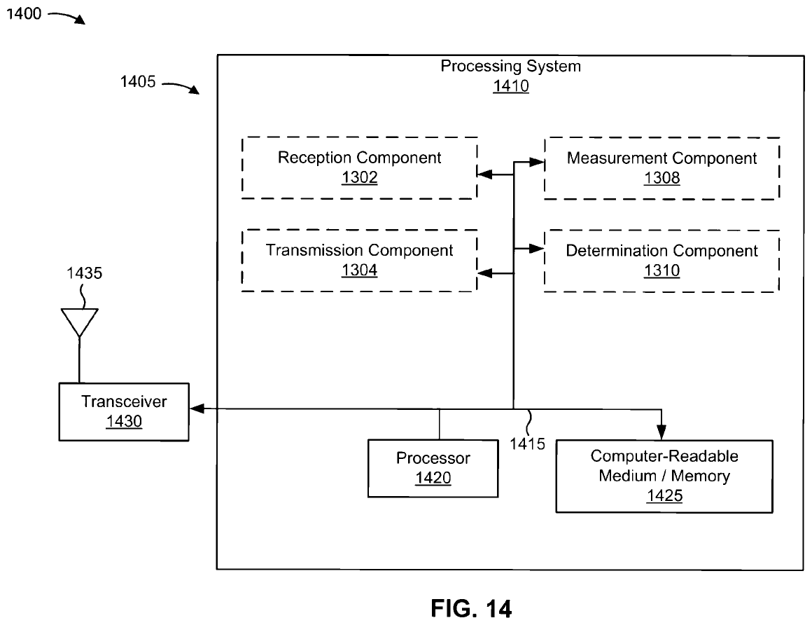

FIG. 14 is a diagram illustrating an example 1400 of a hardware implementation for an apparatus 1405 employing a processing system 1410, in accordance with the present disclosure. The apparatus 1405 may be a UE.

The processing system 1410 may be implemented with a bus architecture, represented generally by the bus 1415. The bus 1415 may include any number of interconnecting buses and bridges depending on the specific application of the processing system 1410 and the overall design constraints. The bus 1415 links together various circuits including one or more processors and/or hardware components, represented by the processor 1420, the illustrated components, and the computer-readable medium/memory 1425. The processor 1420 may include multiple processors, and/or the memory 1425 may include multiple memories. The bus 1415 may also link various other circuits, such as timing sources, peripherals, voltage regulators, and/or power management circuits.

The processing system 1410 may be coupled to a transceiver 1430. The transceiver 1430 is coupled to one or more antennas 1435. The transceiver 1430 provides a means for communicating with various other apparatuses over a transmission medium. The transceiver 1430 receives a signal from the one or more antennas 1435, extracts information from the received signal, and provides the extracted information to the processing system 1410, specifically the reception component 1302. In addition, the transceiver 1430 receives information from the processing system 1410, specifically the transmission component 1304, and generates a signal to be applied to the one or more antennas 1435 based at least in part on the received information.

The processing system 1410 includes a processor 1420 coupled to a computer-readable medium/memory 1425. The processor 1420 is responsible for general processing, including the execution of software stored on the computer-readable medium/memory 1425. The software, when executed by the processor 1420, causes the processing system 1410 to perform the various functions described herein for any particular apparatus. The computer-readable medium/memory 1425 may also be used for storing data that is manipulated by the processor 1420 when executing software. The processing system further includes at least one of the illustrated components. The components may be software modules running in the processor 1420, resident/stored in the computer-readable medium/memory 1425, one or more hardware modules coupled to the processor 1420, or some combination thereof.

In some aspects, the processing system 1410 may be a component of the UE 120 and may include the memory 282 and/or at least one of the TX MIMO processor 266, the receive (RX) processor 258, and/or the controller/processor 280. In some aspects, the apparatus 1405 for wireless communication includes means for performing a measurement on a reference signal; means for determining a precoding matrix based on the measurement; means for applying a phase rotation to the precoding matrix to generate a rotated precoding matrix; and/or means for transmitting a report based at least in part on the rotated precoding matrix. Additionally, or alternatively, the apparatus 1405 for wireless communication includes means for performing a measurement on a reference signal and/or means for transmitting a meta indicator representing one or more properties associated with processing of the reference signal at the apparatus 1405. The aforementioned means may be one or more of the aforementioned components of the apparatus 1300 and/or the processing system 1410 of the apparatus 1405 configured to perform the functions recited by the aforementioned means. As described elsewhere herein, the processing system 1410 may include the TX MIMO processor 266, the RX processor 258, and/or the controller/processor 280. In one configuration, the aforementioned means may be the TX MIMO processor 266, the RX processor 258, and/or the controller/processor 280 configured to perform the functions and/or operations recited herein.

FIG. 14 is provided as an example. Other examples may differ from what is described in connection with FIG. 14.

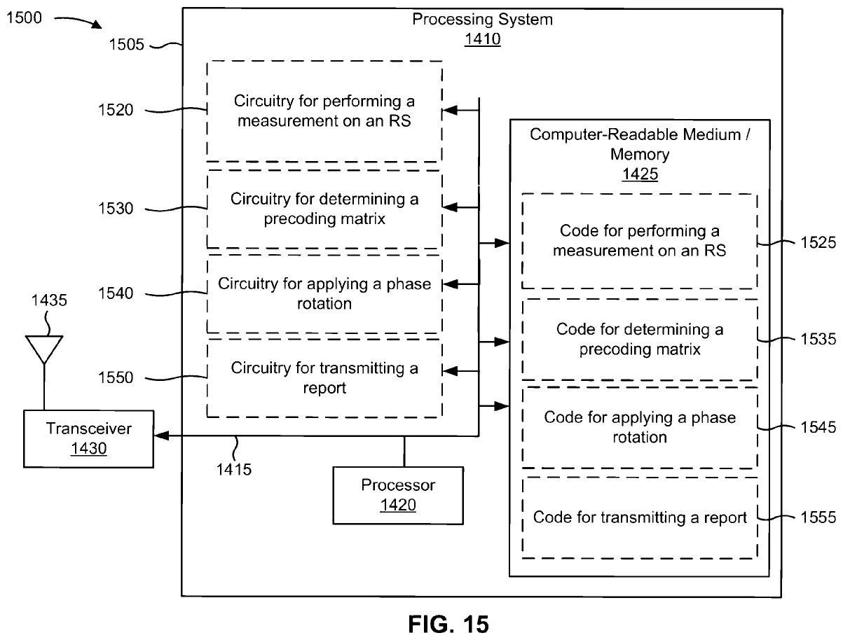

FIG. 15 is a diagram illustrating an example 1500 of an implementation of code and circuitry for an apparatus 1505, in accordance with the present disclosure. The circuitry may include processing circuitry and memory circuitry. The apparatus 1505 may be a UE, or a UE may include the apparatus 1505.

As shown in FIG. 15, the apparatus 1505 may include circuitry for performing a measurement on a reference signal (circuitry 1520). For example, the circuitry 1520 may enable the apparatus 1505 to perform a measurement on a reference signal.

As shown in FIG. 15, the apparatus 1505 may include, stored in computer-readable medium 1425, code for performing a measurement on a reference signal (code 1525). For example, the code 1525, when executed by processor 1420, may cause processor 1420 to cause transceiver 1430 to perform a measurement on a reference signal.

As shown in FIG. 15, the apparatus 1505 may include circuitry for determining a precoding matrix based on the measurement (circuitry 1530). For example, the circuitry 1530 may enable the apparatus 1505 to determine a precoding matrix based on the measurement.

As shown in FIG. 15, the apparatus 1505 may include, stored in computer-readable medium 1425, code for determining a precoding matrix based on the measurement (code 1535). For example, the code 1535, when executed by processor 1420, may cause processor 1420 to determine a precoding matrix based on the measurement.

As shown in FIG. 15, the apparatus 1505 may include circuitry for applying a phase rotation to the precoding matrix to generate a rotated precoding matrix (circuitry 1540). For example, the circuitry 1540 may enable the apparatus 1505 to apply a phase rotation to the precoding matrix to generate a rotated precoding matrix.

As shown in FIG. 15, the apparatus 1505 may include, stored in computer-readable medium 1425, code for applying a phase rotation to the precoding matrix to generate a rotated precoding matrix (code 1545). For example, the code 1545, when executed by processor 1420, may cause processor 1420 to apply a phase rotation to the precoding matrix to generate a rotated precoding matrix.

As shown in FIG. 15, the apparatus 1505 may include circuitry for transmitting a report based at least in part on the rotated precoding matrix (circuitry 1550). For example, the circuitry 1550 may enable the apparatus 1505 to transmit a report based at least in part on the rotated precoding matrix. Additionally, or alternatively, the report may include an indication of the measurement on the reference signal and a meta indicator representing one or more properties associated with reception at the apparatus 1505. For example, the circuitry 1550 may enable the apparatus 1505 to transmit an indication of the measurement on the reference signal and a meta indicator representing one or more properties associated with reception at the transceiver 1430.

As shown in FIG. 15, the apparatus 1505 may include, stored in computer-readable medium 1425, code for transmitting a report based at least in part on the rotated precoding matrix (code 1555). For example, the code 1555, when executed by processor 1420, may cause processor 1420 to cause transceiver 1430 to transmit a report based at least in part on the rotated precoding matrix. Additionally, or alternatively, the report may include an indication of the measurement on the reference signal and a meta indicator representing one or more properties associated with reception at the apparatus 1505. For example, the code 1555, when executed by processor 1420, may cause processor 1420 to cause transceiver 1430 to transmit an indication of the measurement on the reference signal and a meta indicator representing one or more properties associated with reception at the transceiver 1430.

FIG. 15 is provided as an example. Other examples may differ from what is described in connection with FIG. 15.

FIG. 16 is a diagram of an example apparatus 1600 for wireless communication, in accordance with the present disclosure. The apparatus 1600 may be a network node, or a network node may include the apparatus 1600. In some aspects, the apparatus 1600 includes a reception component 1602 and a transmission component 1604, which may be in communication with one another (for example, via one or more buses and/or one or more other components). As shown, the apparatus 1600 may communicate with another apparatus 1606 (such as a UE, an RU, or another wireless communication device) using the reception component 1602 and the transmission component 1604. As further shown, the apparatus 1600 may include the communication manager 150. The communication manager 150 may include one or more of a training component 1608, a refinement component 1610, and/or a decoder component 1612, among other examples.

In some aspects, the apparatus 1600 may be configured to perform one or more operations described herein in connection with FIGS. 7, 8A, and/or 8B. Additionally, or alternatively, the apparatus 1600 may be configured to perform one or more processes described herein, such as process 1000 of FIG. 10, process 1200 of FIG. 12, or a combination thereof. In some aspects, the apparatus 1600 and/or one or more components shown in FIG. 15 may include one or more components of the network node described in connection with FIG. 2. Additionally, or alternatively, one or more components shown in FIG. 16 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1602 may receive communications, such as reference signals, control information, data communications, or a combination thereof, from the apparatus 1606. The reception component 1602 may provide received communications to one or more other components of the apparatus 1600. In some aspects, the reception component 1602 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1600. In some aspects, the reception component 1602 may include one or more antennas, a modem, a demodulator, a MIMO detector, a receive processor, a controller/processor, a memory, or a combination thereof, of the network node described in connection with FIG. 2.

The transmission component 1604 may transmit communications, such as reference signals, control information, data communications, or a combination thereof, to the apparatus 1606. In some aspects, one or more other components of the apparatus 1600 may generate communications and may provide the generated communications to the transmission component 1604 for transmission to the apparatus 1606. In some aspects, the transmission component 1604 may perform signal processing on the generated communications (such as filtering, amplification, modulation, digital-to-analog conversion, multiplexing, interleaving, mapping, or encoding, among other examples), and may transmit the processed signals to the apparatus 1606. In some aspects, the transmission component 1604 may include one or more antennas, a modem, a modulator, a transmit MIMO processor, a transmit processor, a controller/processor, a memory, or a combination thereof, of the network node described in connection with FIG. 2. In some aspects, the transmission component 1604 may be co-located with the reception component 1602 in a transceiver.

In some aspects, the transmission component 1604 may transmit a reference signal. The reception component 1602 may receive a report based at least in part on a rotated precoding matrix based on a first SVD algorithm and a measurement of the reference signal. The reception component 1602 may further receive output from a decoder trained on output from a second SVD algorithm and accepting input from the report.

In some aspects, the training component 1608 may train a machine learning model based at least in part on the rotated precoding matrix. Alternatively, the refinement component 1610 may refine the machine learning model based at least in part on the output. Alternatively, the decoder component 1612 may apply the decoder to the output to determine a reconstructed precoding matrix. Accordingly, the transmission component 1604 may transmit downlink scheduling information based on the reconstructed precoding matrix.

Additionally, or alternatively, the transmission component 1604 may transmit a reference signal. Accordingly, the reception component 1602 may receive a meta indicator representing one or more properties associated with processing at the apparatus 1606 (e.g., associated with processing of the reference signal at the apparatus 1606). Therefore, the training component 1608 may train a machine learning model based at least in part on the measurement and the meta indicator. Alternatively, the refinement component 1610 may refine the machine learning model based at least in part on the measurement and the meta indicator. Additionally, or alternatively, the transmission component 1604 may transmit a model indicator in response to the meta indicator.

The number and arrangement of components shown in FIG. 16 are provided as an example. In practice, there may be additional components, fewer components, different components, or differently arranged components than those shown in FIG. 16. Furthermore, two or more components shown in FIG. 16 may be implemented within a single component, or a single component shown in FIG. 16 may be implemented as multiple, distributed components. Additionally, or alternatively, a set of (one or more) components shown in FIG. 16 may perform one or more functions described as being performed by another set of components shown in FIG. 16.

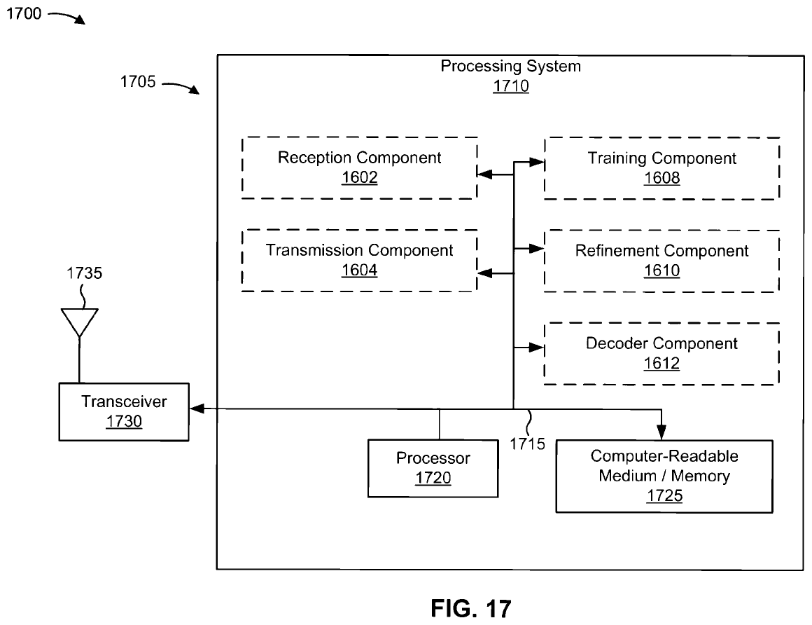

FIG. 17 is a diagram illustrating an example 1700 of a hardware implementation for an apparatus 1705 employing a processing system 1710, in accordance with the present disclosure. The apparatus 1705 may be a network node.

The processing system 1710 may be implemented with a bus architecture, represented generally by the bus 1715. The bus 1715 may include any number of interconnecting buses and bridges depending on the specific application of the processing system 1710 and the overall design constraints. The bus 1715 links together various circuits including one or more processors and/or hardware components, represented by the processor 1720, the illustrated components, and the computer-readable medium/memory 1725. The processor 1720 may include multiple processors, and/or the memory 1725 may include multiple memories. The bus 1715 may also link various other circuits, such as timing sources, peripherals, voltage regulators, and/or power management circuits.

The processing system 1710 may be coupled to a transceiver 1730. The transceiver 1730 is coupled to one or more antennas 1735. The transceiver 1730 provides a means for communicating with various other apparatuses over a transmission medium. The transceiver 1730 receives a signal from the one or more antennas 1735, extracts information from the received signal, and provides the extracted information to the processing system 1710, specifically the reception component 1602. In addition, the transceiver 1730 receives information from the processing system 1710, specifically the transmission component 1604, and generates a signal to be applied to the one or more antennas 1735 based at least in part on the received information.

The processing system 1710 includes a processor 1720 coupled to a computer-readable medium/memory 1725. The processor 1720 is responsible for general processing, including the execution of software stored on the computer-readable medium/memory 1725. The software, when executed by the processor 1720, causes the processing system 1710 to perform the various functions described herein for any particular apparatus. The computer-readable medium/memory 1725 may also be used for storing data that is manipulated by the processor 1720 when executing software. The processing system further includes at least one of the illustrated components. The components may be software modules running in the processor 1720, resident/stored in the computer-readable medium/memory 1725, one or more hardware modules coupled to the processor 1720, or some combination thereof.

In some aspects, the processing system 1710 may be a component of the network node 110 and may include the memory 242 and/or at least one of the TX MIMO processor 230, the RX processor 238, and/or the controller/processor 240. In some aspects, the apparatus 1505 for wireless communication includes means for transmitting a reference signal; means for receiving a report based at least in part on a rotated precoding matrix based on a first SVD algorithm and a measurement of the reference signal; and/or means for receiving output from a decoder trained on output from a second SVD algorithm and accepting input from the report. Additionally, or alternatively, the apparatus 1505 for wireless communication includes means for transmitting a reference signal and/or means for receiving a meta indicator representing one or more properties associated with processing of the reference signal at a UE. The aforementioned means may be one or more of the aforementioned components of the apparatus 1600 and/or the processing system 1710 of the apparatus 1705 configured to perform the functions recited by the aforementioned means. As described elsewhere herein, the processing system 1710 may include the TX MIMO processor 230, the receive processor 238, and/or the controller/processor 240. In one configuration, the aforementioned means may be the TX MIMO processor 230, the receive processor 238, and/or the controller/processor 240 configured to perform the functions and/or operations recited herein.

FIG. 17 is provided as an example. Other examples may differ from what is described in connection with FIG. 17.

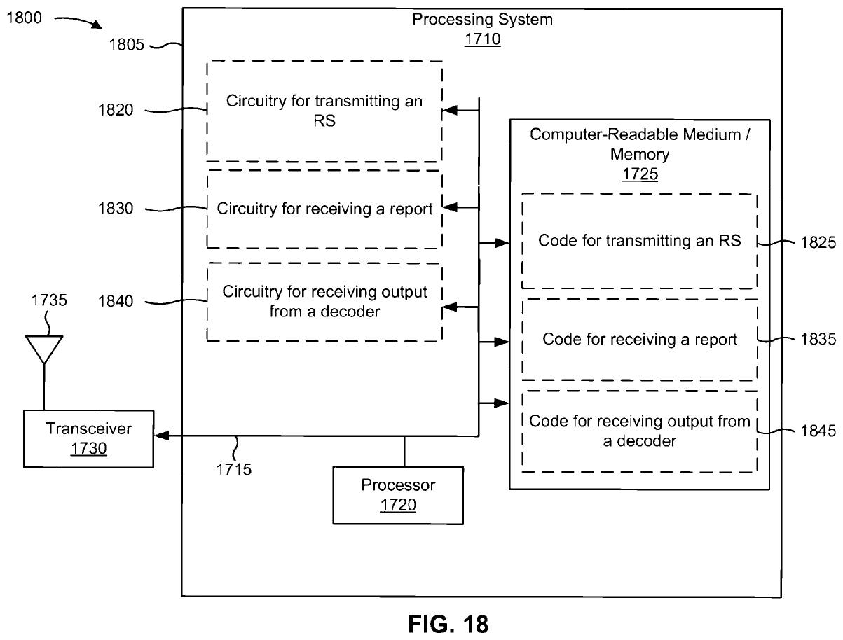

FIG. 18 is a diagram illustrating an example 1800 of an implementation of code and circuitry for an apparatus 1805, in accordance with the present disclosure. The circuitry may include processing circuitry and memory circuitry. The apparatus 1805 may be a network node, or a network node may include the apparatus 1805.

As shown in FIG. 18, the apparatus 1805 may include circuitry for transmitting a reference signal (circuitry 1820). For example, the circuitry 1820 may enable the apparatus 1805 to transmit a reference signal.

As shown in FIG. 18, the apparatus 1805 may include, stored in computer-readable medium 1725, code for transmitting a reference signal (code 1825). For example, the code 1825, when executed by processor 1720, may cause processor 1720 to cause transceiver 1730 to transmit a reference signal.

As shown in FIG. 18, the apparatus 1805 may include circuitry for receiving a report based at least in part on a rotated precoding matrix based on a first SVD algorithm and a measurement of the reference signal (circuitry 1830). For example, the circuitry 1830 may enable the apparatus 1805 to receive a report based at least in part on a rotated precoding matrix based on a first SVD algorithm and a measurement of the reference signal. Additionally, or alternatively, the report may include an indication of the measurement on the reference signal and a meta indicator representing one or more properties associated with reception at a UE. For example, the circuitry 1830 may enable the apparatus 1805 to receive a meta indicator representing one or more properties associated with processing of the reference signal at the UE.

As shown in FIG. 18, the apparatus 1805 may include, stored in computer-readable medium 1725, code for receiving a report based at least in part on a rotated precoding matrix based on a first SVD algorithm and a measurement of the reference signal (code 1835). For example, the code 1835, when executed by processor 1720, may cause processor 1720 to cause transceiver 1730 to receive a report based at least in part on a rotated precoding matrix based on a first SVD algorithm and a measurement of the reference signal. Additionally, or alternatively, the report may include an indication of the measurement on the reference signal and a meta indicator representing one or more properties associated with reception at a UE. For example, the code 1835, when executed by processor 1720, may cause processor 1720 to cause transceiver 1730 to receive a meta indicator representing one or more properties associated with processing of the reference signal at the UE.

As shown in FIG. 18, the apparatus 1805 may include circuitry for receiving output from a decoder trained on output from a second SVD algorithm and accepting input from the report (circuitry 1840). For example, the circuitry 1840 may enable the apparatus 1805 to receive output from a decoder trained on output from a second SVD algorithm and accepting input from the report.

As shown in FIG. 18, the apparatus 1805 may include, stored in computer-readable medium 1725, code for receiving output from a decoder trained on output from a second SVD algorithm and accepting input from the report (code 1845). For example, the code 1845, when executed by processor 1720, may cause processor 1720 to receive output from a decoder trained on output from a second SVD algorithm and accepting input from the report.

FIG. 18 is provided as an example. Other examples may differ from what is described in connection with FIG. 18.

The following provides an overview of some Aspects of the present disclosure:

Aspect 1: A method of wireless communication performed at a user equipment (UE), comprising: performing a measurement on a reference signal; determining a precoding matrix based on the measurement; applying a phase rotation to the precoding matrix to generate a rotated precoding matrix; and transmitting a report based at least in part on the rotated precoding matrix.

Aspect 2: The method of Aspect 1, wherein the reference signal comprises a channel state information reference signal.

Aspect 3: The method of any of Aspects 1-2, wherein the measurement comprises a channel matrix.

Aspect 4: The method of any of Aspects 1-3, wherein determining the precoding matrix comprises: applying singular value decomposition to a matrix representing the measurement to determine the precoding matrix.

Aspect 5: The method of any of Aspects 1-4, wherein applying the phase rotation comprises: selecting a phase of a first entry in the precoding matrix associated with a first layer and a first subband as a first phase multiplier; and applying the first phase multiplier to remaining entries associated with the first layer and the first subband in the precoding matrix.

Aspect 6: The method of Aspect 5, wherein applying the phase rotation further comprises: selecting a phase of a first entry in the precoding matrix associated with the first layer and a second subband as a second phase multiplier; and applying the second phase multiplier to remaining entries associated with the first layer and the second subband in the precoding matrix.

Aspect 7: The method of any of Aspects 5-6, wherein applying the phase rotation further comprises: selecting a phase of a first entry in the precoding matrix associated with a second layer and the first subband as a second phase multiplier; and applying the second phase multiplier to remaining entries associated with the second layer and the first subband in the precoding matrix.

Aspect 8: The method of any of Aspects 1-4, wherein applying the phase rotation comprises: determining a matrix of frequency correlations associated with a first layer aggregated across weights associated with one or more antenna ports; applying singular value decomposition to the matrix of frequency correlations to generate an eigenvector associated with the first layer; and applying a phase multiplier associated with a first subband and indicated in the eigenvector to entries in the precoding matrix associated with the first layer and the first subband.

Aspect 9: The method of Aspect 8, wherein applying the phase rotation further comprises: applying phase multipliers associated with a second subband and indicated in the eigenvector to entries in the precoding matrix associated with the first layer and the second subband.

Aspect 10: The method of any of Aspects 8-9, wherein applying the phase rotation further comprises: determining an additional matrix of frequency correlations associated with a second layer aggregated across additional weights associated with the one or more antenna ports; applying singular value decomposition to the additional matrix of frequency correlations to generate an additional eigenvector associated with the second layer; and applying a phase multiplier indicated in the additional eigenvector to entries in the precoding matrix associated with the second layer and the first subband.

Aspect 11: The method of any of Aspects 1-4, wherein applying the phase rotation comprises: determining a delay associated with the precoding matrix using an inverse fast Fourier transform; and applying a set of phase multipliers to the precoding matrix based on applying a minimization function to the delay.

Aspect 12: The method of any of Aspects 1-11, wherein the report indicates the rotated precoding matrix.

Aspect 13: The method of any of Aspects 1-11, wherein the report indicates output from a machine learning model that accepts the rotated precoding matrix as input.

Aspect 14: The method of any of Aspects 1-11, wherein the report indicates at least one precoding matrix indicator selected using the rotated precoding matrix.

Aspect 15: A method of wireless communication performed at a network node, comprising: transmitting a reference signal; receiving a report based at least in part on a rotated precoding matrix based on a first singular value decomposition (SVD) algorithm and a measurement of the reference signal; and receiving output from a decoder trained on output from a second SVD algorithm and accepting input from the report.

Aspect 16: The method of Aspect 15, wherein the reference signal comprises a channel state information reference signal.

Aspect 17: The method of any of Aspects 15-16, wherein the measurement comprises a channel matrix.

Aspect 18: The method of any of Aspects 15-17, wherein a phase of a first entry in the rotated precoding matrix is zero.

Aspect 19: The method of any of Aspects 15-18, wherein a portion of the rotated precoding matrix associated with a first subband is associated with a first phase rotation and a portion of the rotated precoding matrix associated with a second subband is associated with a second phase rotation.

Aspect 20: The method of any of Aspects 15-19, wherein a portion of the rotated precoding matrix associated with a first layer is associated with a first phase rotation and a portion of the rotated precoding matrix associated with a second layer is associated with a second phase rotation.

Aspect 21: The method of any of Aspects 15-20, wherein the report indicates the rotated precoding matrix.

Aspect 22: The method of Aspect 21, further comprising: training a machine learning model based at least in part on the rotated precoding matrix.

Aspect 23: The method of any of Aspects 15-20, wherein the report indicates output from a machine learning model that accepts the rotated precoding matrix as input.

Aspect 24: The method of Aspect 23, further comprising: refining the machine learning model based at least in part on the output.

Aspect 25: The method of Aspect 23, further comprising: applying a decoder to the output to determine a reconstructed precoding matrix; and transmitting downlink scheduling information based on the reconstructed precoding matrix.

Aspect 26: The method of any of Aspects 15-20, wherein the report indicates at least one precoding matrix indicator (PMI) based on the rotated precoding matrix.

Aspect 27: The method of Aspect 26, further comprising: transmitting downlink scheduling information based on the at least one PMI.

Aspect 28: A method of wireless communication performed at a user equipment (UE), comprising: performing a measurement on a reference signal; and transmitting transmit a meta indicator representing one or more properties associated with processing of the reference signal at the UE.

Aspect 29: The method of Aspect 28, wherein the meta indicator comprises an alphanumeric indicator selected from a plurality of possible indicators using the one or more properties.

Aspect 30: The method of any of Aspects 28-29, wherein the meta indicator is associated with a cluster of UEs, from a plurality of possible clusters, that includes the UE.

Aspect 31: The method of any of Aspects 28-30, wherein the measurement is performed as part of a data collection phase.

Aspect 32: The method of any of Aspects 28-31, wherein the one or more properties comprise: a precoder applied by the UE; an antenna configuration associated with the UE; a beamforming configuration used by the UE; a phase rotation algorithm applied by the UE; or a singular value decomposition algorithm applied by the UE.

Aspect 33: The method of any of Aspects 28-32, further comprising: receiving a model indicator in response to transmission of the meta indicator.

Aspect 34: A method of wireless communication performed at a network node, comprising: transmitting a reference signal; and receiving a meta indicator representing one or more properties associated with processing of the reference signal at a user equipment (UE).

Aspect 35: The method of Aspect 34, wherein the meta indicator comprises an alphanumeric indicator selected from a plurality of possible indicators using the one or more properties.

Aspect 36: The method of any of Aspects 34-35, wherein the meta indicator is associated with a cluster of UEs, from a plurality of possible clusters, that includes the UE.

Aspect 37: The method of any of Aspects 34-36, wherein the reference signal is transmitted as part of a data collection phase.

Aspect 38: The method of any of Aspects 34-37, wherein the one or more properties comprise: a precoder applied by the UE; an antenna configuration associated with the UE; a beamforming configuration used by the UE; a phase rotation algorithm applied by the UE; or a singular value decomposition algorithm applied by the UE.

Aspect 39: The method of any of Aspects 34-38, further comprising: transmitting a model indicator in response to reception of the meta indicator.

Aspect 40: An apparatus for wireless communication at a device, comprising one or more processors; one or more memories coupled with the processor; and instructions stored in the one or more memories and executable by the one or more processors to cause the apparatus to perform the method of one or more of Aspects 1-39.

Aspect 41: A device for wireless communication, comprising a one or more memories and one or more processors coupled to the one or more memories, the one or more processors configured to cause the device to perform the method of one or more of Aspects 1-39.

Aspect 42: An apparatus for wireless communication, comprising at least one means for performing the method of one or more of Aspects 1-39.

Aspect 43: A non-transitory computer-readable medium storing code for wireless communication, the code comprising instructions executable by a processor to perform the method of one or more of Aspects 1-39.

Aspect 44: A non-transitory computer-readable medium storing a set of instructions for wireless communication, the set of instructions comprising one or more instructions that, when executed by one or more processors of a device, cause the device to perform the method of one or more of Aspects 1-39.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. An apparatus for wireless communication at a user equipment (UE), comprising:
one or more memories; and
one or more processors coupled to the one or more memories, the one or more processors configured to cause the UE to:
perform a measurement on a reference signal;
determine a precoding matrix based on the measurement;
apply a phase rotation to the precoding matrix to generate a rotated precoding matrix; and
transmit a report based at least in part on the rotated precoding matrix.

2. The apparatus of claim 1, wherein, to determine the precoding matrix, the one or more processors are configured to cause the UE to:
apply singular value decomposition to a matrix representing the measurement to determine the precoding matrix.

3. The apparatus of claim 1, wherein, to apply the phase rotation, the one or more processors are configured to cause the UE to:
select a phase of a first entry in the precoding matrix associated with a first layer and a first subband as a first phase multiplier; and
apply the first phase multiplier to remaining entries associated with the first layer and the first subband in the precoding matrix.

4. (canceled)

5. (canceled)

6. The apparatus of claim 1, wherein, to apply the phase rotation, the one or more processors are configured to cause the UE to:
determine a matrix of frequency correlations associated with a first layer aggregated across weights associated with one or more antenna ports;
apply singular value decomposition to the matrix of frequency correlations to generate an eigenvector associated with the first layer; and
apply a phase multiplier associated with a first subband and indicated in the eigenvector to entries in the precoding matrix associated with the first layer and the first subband.

7. (canceled)

8. (canceled)

9. The apparatus of claim 1, wherein, to apply the phase rotation, the one or more processors are configured to cause the UE to:
determine a delay associated with the precoding matrix using an inverse fast Fourier transform; and
apply a set of phase multipliers to the precoding matrix based on applying a minimization function to the delay.

10. (canceled)

11. An apparatus for wireless communication at a network node, comprising:
one or more memories; and
one or more processors coupled to the one or more memories, the one or more processors configured to cause the network node to:
transmit a reference signal;
receive a report based at least in part on a rotated precoding matrix based on a first singular value decomposition (SVD) algorithm and a measurement of the reference signal; and
receive output from a decoder trained on output from a second SVD algorithm and accepting input from the report.

12. The apparatus of claim 11, wherein a portion of the rotated precoding matrix associated with a first subband is associated with a first phase rotation and a portion of the rotated precoding matrix associated with a second subband is associated with a second phase rotation.

13. The apparatus of claim 11, wherein a portion of the rotated precoding matrix associated with a first layer is associated with a first phase rotation and a portion of the rotated precoding matrix associated with a second layer is associated with a second phase rotation.

14. The apparatus of claim 11, wherein the report indicates the rotated precoding matrix.

15. (canceled)

16. The apparatus of claim 11, wherein the report indicates output from a machine learning model accepting the rotated precoding matrix as input.

17. (canceled)

18. (canceled)

19. An apparatus for wireless communication at a user equipment (UE), comprising:
one or more memories; and
one or more processors coupled to the one or more memories, the one or more processors configured to cause the UE to:
perform a measurement on a reference signal; and
transmit a meta indicator representing one or more properties associated with processing of the reference signal at the UE.

20. The apparatus of claim 19, wherein the meta indicator comprises an alphanumeric indicator selected from a plurality of possible indicators using the one or more properties.

21. The apparatus of claim 19, wherein the meta indicator is associated with a cluster of UEs, from a plurality of possible clusters, that includes the UE.

22. The apparatus of claim 19, wherein the measurement is performed as part of a data collection phase.

23. The apparatus of claim 19, wherein the one or more properties comprise:
a precoder applied by the UE;
an antenna configuration associated with the UE;
a beamforming configuration used by the UE;
a phase rotation algorithm applied by the UE; or
a singular value decomposition algorithm applied by the UE.

24. (canceled)

25. An apparatus for wireless communication at a network node, comprising:
one or more memories; and
one or more processors coupled to the one or more memories, the one or more processors configured to cause the network node to:
transmit a reference signal; and
receive a meta indicator representing one or more properties associated with processing of the reference signal at a user equipment (UE).

26. The apparatus of claim 25, wherein the meta indicator comprises an alphanumeric indicator selected from a plurality of possible indicators using the one or more properties.

27. The apparatus of claim 25, wherein the meta indicator is associated with a cluster of UEs, from a plurality of possible clusters, that includes the UE.

28. (canceled)

29. The apparatus of claim 25, wherein the one or more properties comprise:
a precoder applied by the UE;
an antenna configuration associated with the UE;
a beamforming configuration used by the UE;
a phase rotation algorithm applied by the UE; or
a singular value decomposition algorithm applied by the UE.

30. The apparatus of claim 25, wherein the one or more processors are configured to cause the network node to:
transmit a model indicator in response to reception of the meta indicator.
